(19) United States
(12) Patent Application Publication
(10) Pub. No.: US 2026/0051190 A1
(43) Pub. Date: Feb. 19, 2026

(54) INFORMATION PROCESSING APPARATUS, INFORMATION PROCESSING METHOD, AND RECORDING MEDIUM

(71) Applicant: NS Solutions Corporation, Tokyo (JP)

(72) Inventor: Masataka FUJIWARA, Tokyo (JP)

(21) Appl. No.: 19/290,058

(22) Filed: Aug. 4, 2025

(30) Foreign Application Priority Data
Aug. 15, 2024 (JP) 2024-135675
Jun. 17, 2025 (JP) 2025-101300

(51) Int. Cl. G06V 30/19; G06V 10/74; G06V 10/772; G06V 10/82; G06V 30/194; G06V 30/414

(52) U.S. Cl. CPC G06V 30/1914; G06V 10/761; G06V 10/772; G06V 30/194; G06V 30/414; G06V 10/82

(57) ABSTRACT

An information processing apparatus comprises: an acquisitor to obtain document information, including character strings and position data from document image data; a converter to transform the acquired document information into a distributed representation; an information extractor to identify a character string corresponding to an item specified by a prompt, using a large language model by inputting the prompt with the acquired document information; a storage unit to save the document information, distributed representation, and extraction results, associating them with the document; and a selector to choose a reference document from previously processed documents based on distributed representations. The prompt for processing a new document includes details about the selected reference document.

### CROSS-REFERENCE TO RELATED APPLICATIONS

This application is based upon and claims the benefit of priority of the prior Japanese Patent Application No. 2024-135675, filed on Aug. 15, 2024, and the prior Japanese Patent Application No. 2025-101300, filed on Jun. 17, 2025, the entire contents of which are incorporated herein by reference.

### BACKGROUND OF THE INVENTION

### Field of the Invention

The present invention relates to an information processing apparatus, an information processing method, and a recording medium.

### Description of the Related Art

A technology for extracting handwritten or printed character strings from image data of a document or the like using optical character recognition (OCR) processing is known. There is technology for extracting character strings corresponding to a specified item by performing optical character recognition processing on image data of a document or the like. Methods for extracting a character string corresponding to a specified item include, for example, extracting the character string that is positioned in a predetermined direction with respect to an item name in a document and extracting character strings that satisfy conditions (constraints) included in image data as candidate character strings to determine and extract one character string from the candidate character strings based on their number of appearances in the image data.
Patent Document 1: Japanese Laid-open Patent Publication No. 2023-46684

However, if the item name related to the item from which a character string is to be extracted is not included in the image data, the character string corresponding to the item cannot always be extracted with high accuracy. In addition, when the item name of the item from which a character string is to be extracted differs from the item name included in the image data, for example, in such a case where the item from which a character string is to be extracted is “delivery location” and the character string in the image data indicates the delivery location but with the item name of “destination,” the character string corresponding to the item cannot always be extracted with high accuracy.

### SUMMARY OF THE INVENTION

An object of the present invention is to provide an information processing apparatus, an information processing method, and a recording medium that extracts a character string corresponding to a desired item from image data of a document with high accuracy.

The information processing apparatus according to the present invention includes: an acquisitor configured to acquire a character string included in image data of a document and position information indicating a position of the character string as document information; a converter configured to convert the document information acquired into a distributed representation; an information extractor configured to extract a character string corresponding to an item instructed by a prompt, by performing inference with a large language model by inputting the prompt including the document information acquired into the large language model; a storage configured to store the document information, the distributed representation, and an extraction result by the information extractor, related to a document in a storage unit while associating them with each other; and a selector configured to select a reference document from among documents processed in a past based on a distributed representation related to a document to be processed and distributed representations related to the documents processed in the past stored in the storage unit, wherein the prompt to be input for the document to be processed includes information about the reference document selected.

According to the present invention, the information processing apparatus, an information processing method, and a recording medium that extracts the character string corresponding to a desired item from the image data of the document with high accuracy can be provided.

### BRIEF DESCRIPTION OF THE DRAWINGS

FIG. 1 is a diagram illustrating an example of a hardware configuration of an information processing apparatus.

FIG. 2 is a diagram illustrating an example of a functional configuration of the information processing apparatus according to a first embodiment.

FIG. 3 is a view describing an example of processing of the information processing apparatus according to the first embodiment.

FIG. 4 is a flowchart illustrating an example of processing of the information processing apparatus according to the first embodiment.

FIG. 5A is a view describing an example of a document.

FIG. 5B is a view describing an example of document information.

FIG. 5C is a view describing an example of distributed representations.

FIG. 6A is a view describing modification of an extraction result (before modification).

FIG. 6B is a view describing modification of the extraction result (after modification).

FIG. 7 is a view describing an example of a prompt related to extraction of information.

FIG. 8A is a view describing an example of the prompt related to extraction of information.

FIG. 8B is a view describing an example of the prompt related to extraction of information.

FIG. 8C is a view describing an example of the prompt related to extraction of information.

FIG. 9 is a view describing an example of output of a processing result.

FIG. 10 is a diagram illustrating an example of a functional configuration of an information processing apparatus according to a second embodiment.

FIG. 11 is a view describing an example of processing of the information processing apparatus according to the second embodiment.

FIG. 12 is a flowchart illustrating an example of processing of the information processing apparatus according to the second embodiment.

FIG. 13 is a flowchart illustrating an example of an acquisition process of IoU with respect to character regions.

FIG. 14 is a view describing the IoU with respect to the character regions.

FIG. 15 is a view describing information related to documents processed in the past.

FIG. 16 is a diagram illustrating an example of a functional configuration of an information processing apparatus according to a third embodiment.

FIG. 17 is a flowchart illustrating an example of processing of the information processing apparatus according to the third embodiment.

FIG. 18 is a view describing information related to documents processed in the past.

FIG. 19A is a view describing an example of the information related to the documents processed in the past.

FIG. 19B is a view describing an example of the information related to the documents processed in the past.

FIG. 20 is a view describing an example of a prompt related to extraction of information.

### DETAILED DESCRIPTION OF THE PREFERRED EMBODIMENTS

Embodiments of the present invention are described with reference to the drawings.

### First Embodiment

An information processing apparatus according to a first embodiment described below uses optical character recognition (OCR) processing and a large language model (LLM) to extract information (character string) corresponding to an item instructed from image data of a document. The information processing apparatus according to the embodiment performs inference with the large language model by inputting a prompt including information on an item from which information (character string) is to be extracted (item name or description of the item), the character string included in the image data of the document, and position information indicating a position of the character string in the document into the large language model, and then extract information (character string) corresponding to a desired item. By inputting the prompt that includes a character string included in image data of the document and position information into the large language model, the large language model can understand the structure of the document and extract information (character string) with consideration of the layout of the document and the like.

However, when so-called tacit knowledge or business knowledge is required to extract information (character string) from a document, the information (character string) corresponding to the desired item may not be properly extracted from the image data of the document. Therefore, in the present embodiment, documents that are similar in format to a document to be processed (hereinafter also referred to as “target document”) from among documents processed in the past are acquired as documents to be referred to in the process of extracting information from the target document (hereinafter also referred to as “reference documents”). Then, by including information from the reference documents in the prompt as examples for few-shot learning and inputting the prompt into the large language model, knowledge equivalent to tacit knowledge, business knowledge, or the like is easily and efficiently learned to extract information (character string) corresponding to the desired item, thereby improving the accuracy of information extraction.

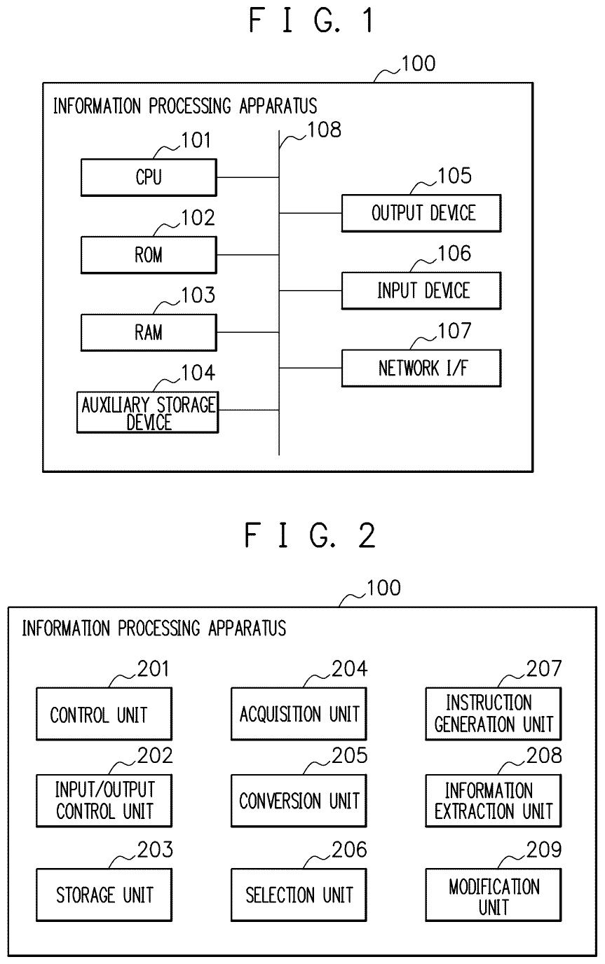

FIG. 1 is a diagram illustrating an example of a hardware configuration of an information processing apparatus 100 according to the embodiment. The information processing apparatus 100 includes a central processing unit (CPU) 101, a read-only memory (ROM) 102, a random-access memory (RAM) 103, an auxiliary storage device 104, an output device 105, an input device 106, and a network I/F 107. The CPU 101, the ROM 102, the RAM 103, the auxiliary storage device 104, the output device 105, the input device 106, and the network I/F 107 are communicatively connected via a system bus 108.

The CPU 101 is a central processing device for controlling various types of operations of the information processing apparatus 100. For example, the CPU 101 may control operations of the entire information processing apparatus 100. The ROM 102 stores control programs, boot programs, and other programs executable by the CPU 101. The RAM 103 is a main storage memory of the CPU 101. The RAM 103 is used as a work area or a temporary storage area for loading various types of programs.

The auxiliary storage device 104 stores various types of data, various types of programs, and the like. The auxiliary storage device 104 is realized by a storage device capable of temporarily or permanently storing various types of data, such as a nonvolatile memory represented by a hard disk drive (HDD) or a solid state drive (SSD).

The output device 105 is a device that outputs various types of information. The output device 105 is used to present various types of information to a user, and the like. For example, the output device 105 is realized by a display device such as a display. The output device 105 may present information to the user by displaying various types of display information. As another example, the output device 105 may be realized by an acoustic output device that outputs sound such as voice or electronic sound. In this case, the output device 105 may present information to the user by outputting sound such as voice or electronic sound. The device applied as the output device 105 may be changed as appropriate depending on a medium used to present information to the user.

The input device 106 is used to receive various types of instructions from the user, or the like. For example, the input device 106 may include an input device such as a mouse, a keyboard, or a touch panel. As another example, the input device 106 may include a sound collection device such as a microphone to capture voice uttered by the user. In this case, various types of analysis processing such as an acoustic analysis and natural language processing may be performed on the voice captured to recognize the contents indicated by the voice as an instruction from the user. The device applied as the input device 106 may be changed as appropriate depending on a method for recognizing an instruction from the user. A plurality of types of devices may be applied as the input device 106.

The network I/F 107 is used for communication via a network with an external device or the like. The device applied as the network I/F 107 may be changed as appropriate depending on a type of communication path or a communication method to be applied.

The CPU 101 loads a program stored in the ROM 102 or the auxiliary storage device 104 into the RAM 103 and executes the program to realize each function and each process, or the like of the information processing apparatus described below. The program for the information processing apparatus 100, for example, may be provided to the information processing apparatus 100 by a recording medium such as a CD-ROM or may be downloaded via a network or the like. When a program for the information processing apparatus 100 is provided by the recording medium, the program recorded on the recording medium is installed in the auxiliary storage device 104 by setting the recording medium in a certain drive device.

The configuration illustrated in FIG. 1 is only an example and does not limit the hardware configuration of the information processing apparatus 100 according to the embodiment. As an example, the information processing apparatus 100 may not be included some configurations such as the output device 105 or the input device 106. As another example, a configuration in accordance with functions to be realized by the information processing apparatus 100 may be added as appropriate to the information processing apparatus 100.

FIG. 2 is a diagram illustrating an example of a functional configuration of the information processing apparatus 100 according to the first embodiment. The information processing apparatus 100 according to the first embodiment includes a control unit 201, an input/output control unit 202, a storage unit 203, an acquisition unit 204, a conversion unit 205, a selection unit 206, an instruction generation unit 207, an information extraction unit 208, and a modification unit 209.

The control unit 201 is responsible for controlling each component of the information processing apparatus 100. The input/output control unit 202 performs various types of processing related to the presentation of various types of information to the user and the reception of information input (for example, an instruction or the like) from the user. For example, the input/output control unit 202 may perform processing related to the presentation of a user interface (UI) or processing related to the reception of input via the UI. Thus, the information processing apparatus 100 can recognize the instruction from the user and present a result of processing in accordance with the instruction to the user.

The storage unit 203 schematically represents a storage area for storing various types of data, various types of programs, and the like. For example, the storage unit 203 may store data or a program for each component of the information processing apparatus 100 to perform a process. The storage unit 203 may store a pre-trained model that has been trained by machine learning (deep learning or hierarchical learning) that is used for inference regarding information extraction performed in the information processing apparatus 100. The storage unit 203 may store document information related to documents, distributed representations obtained by converting the document information, and an extraction result of information on a document.

The acquisition unit 204 acquires image data of a document by optically scanning or capturing the document. The acquisition unit 204 also performs optical character recognition processing on the acquired image data of the document to extract and acquire document information related to the document. The document information includes a character string included in the image data of the document and position information indicating the position of the character string in the document. The acquisition unit 204 may receive and acquire the image data of the document acquired by externally scanning or capturing the document in advance as input without scanning or capturing the document. The acquisition unit 204 may acquire document information by receiving the character string included in the document and its position information that are acquired as a result of an external optical character recognition processing as input.

The conversion unit 205 converts the document information related to the document acquired by the acquisition unit 204 into a distributed representation (embedded representation). The distributed representation of document information is a representation of document information as a multi-dimensional real-number vector, where the vectors indicated by the distributed representations of document information related to similar documents are close vectors (distance between vectors is small). The conversion unit 205, for example, converts document information into a distributed representation using a pre-trained embedding model that converts natural language into a numerical vector. The pre-trained embedding model may apply, for example, a pre-trained embedding model such as Sentence-BERT or OpenAI's text embedding models. It is not limited to these pre-trained embedding models, and a pre-trained embedding model generated by performing machine learning to convert document information into a distributed representation (embedded representation) may also be applied. For example, a pre-trained embedding model may be generated by preparing a large number of pairs of a certain sentence and similar sentences as training data and training the model so that the multi-dimensional vectors generated from similar sentences are similar vectors.

As an example in the present embodiment, the conversion unit 205 converts the character string and position information in document information related to a document (a combination of character string and position information) into a distributed representation for each page of the document (on a page-by-page basis). The conversion is not limited to the above but may be performed by the conversion unit 205 by converting the entire document (on a document-by-document basis) into distributed representations. The conversion unit 205 may convert only the character string in the document information related to the document into a distributed representation or may convert only the position information of the character string in the document information related to the document into a distributed representation. Although a distributed representation is used in the embodiment, other methods different from that with a distributed representation may be used as long as similarities can be evaluated.

The selection unit 206 selects documents (reference documents) to be referred to in the process of extracting information from the document to be processed (target document) from among the documents processed in the past for which the document information, the distributed representations and the extraction result of information that are related to documents are stored in the storage unit 203. The selection unit 206 selects the reference documents from among the documents processed in the past with machine learning (for example, k-nearest neighbor (KNN)) based on the distributed representations related to the documents. Specifically, the selection unit 206 compares the distributed representation related to the target document obtained by the conversion in the conversion unit 205 and the distributed representations related to the documents processed in the past that are stored in the storage unit 203 and selects a certain number of documents that are similar in format to the target document (i.e., documents for which distributed representations are close in distance to the target document) from among the documents processed in the past as reference documents.

Here, because of the similarities in the types of character strings and the sequence of position information in the documents, the distributed representations of the documents that are similar in format tend to be similar, allowing the selection unit 206 to determine documents of similar format with machine learning such as the k-nearest neighbor method. The selection unit 206 can also obtain documents with high similarity by evaluating similarity using the distributed representations of documents even if there are slight deviations in format or differences in contents. The method for comparing the distributed representation related to the target document and the distributed representations related to documents processed in the past is not limited to the k-nearest neighbor method, but other methods can be applied as long as the distributed representations (vectors) are compared with each other. For example, support vector machine (SVM), artificial neural network (ANN), cosine similarity, or the like may be used to compare distributed representations.

In the present embodiment, the instruction generation unit 207 generates an instruction for extracting information (character string) from the target document and inputs the instruction into the information extraction unit 208, and the information extraction unit 208 uses the large language model (LLM) to extract information (character string) in accordance with the input instruction. A large language model (LLM) is a language model built using a large amount of text data (such as a large corpus) and deep learning technology, and when text data called a prompt that indicates the instruction, or the like is input, it performs inference based on the prompt to generate text data corresponding to the input prompt and output them.

The instruction generation unit 207 generates a prompt including the instruction for extracting information (character string) corresponding to the desired item from the target document and the document information of the target document and inputs the prompt into the information extraction unit 208. For inference using a large language model, there is a method called few-shot learning, which improves the accuracy of responses by including examples (samples) in a prompt and taking advantage of the characteristic of large language models of providing output with high accuracy that is adapted to the presented examples (samples). In the present embodiment, when any one of the reference documents selected by the selection unit 206 has a high similarity to the target document (for example, any document with a distance from the target document in the distributed representations equal to or less than a certain threshold), the instruction generation unit 207 generates a prompt with document information and the extraction result related to the selected reference document as examples for few-shot learning and inputs the prompt into the information extraction unit 208. In this way, by providing information (document information and extraction result) about the reference documents that have a high similarity to the target document to the large language model as examples for few-shot learning, knowledge, and the like equivalent to tacit knowledge, business knowledge, or the like can be easily and efficiently learned to extract information (character strings) corresponding to the desired item with high accuracy.

The information extraction unit 208 performs inference with the large language model based on the prompt generated and input by the instruction generation unit 207 to extract information (character string) corresponding to the item instructed to be extracted by the prompt from the image data of the target document. The modification unit 209 receives a modification request from the user for the extraction result of information related to the target document by the information extraction unit 208 and modifies the extraction result in accordance with the modification request. The extraction result of the information related to the target document extracted by the information extraction unit 208 (or the modified extraction result if modification is performed by the modification unit 209) is stored in the storage unit 203 while being associated with the document information acquired by the acquisition unit 204 and the distributed representation obtained by the conversion in the conversion unit 205.

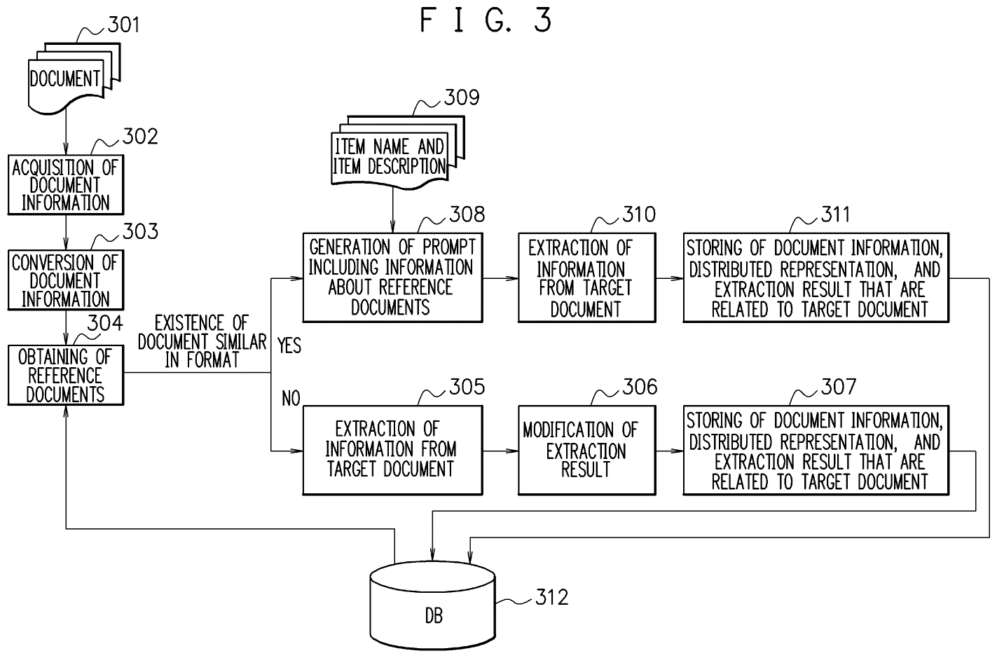

With reference to FIG. 3, the processing in the information processing apparatus 100 according to the first embodiment is described. FIG. 3 is a view describing an example of processing of the information processing apparatus 100 according to the first embodiment.

The information processing apparatus 100 performs an acquisition process 302 of document information to acquire document information (the character string included in the image data and position information of the character string) from the image data of a document to be processed (target document) 301. The information processing apparatus 100 performs a conversion process 303 of the acquired document information related to the target document and converts the document information (the combination of character string and position information) into a distributed representation using a pre-trained embedding model or the like.

Next, the information processing apparatus 100 performs an obtaining process 304 of reference documents to select documents (reference documents) to be referred to in the process of extracting information from the target document from among the documents processed in the past, which are stored in a database (DB) 312. The information processing apparatus 100 compares the distributed representation related to the target document obtained through the conversion process 303 and the distributed representations related to the documents processed in the past that are stored in the database 312 and obtains a certain number of documents in descending order of similarity in the distributed representations with the target document (in ascending order of distance) from among the documents processed in the past as the reference documents. In the present embodiment, the information processing apparatus 100 selects the reference documents from among the documents stored through a storing process 307 described below in the database 312 among the documents processed in the past that are stored in the database 312. This is because the extraction result stored through the storing process 307 described below is the extraction result modified in accordance with the instruction from the user as necessary and is generally considered to be of higher quality than the extraction result stored through a storing process 311.

After obtaining the reference documents through the obtaining process 304, the information processing apparatus 100 determines whether the obtained reference documents include a document similar in format to the target document or not. The information processing apparatus 100 determines, for example, that they include a document similar in format to the target document if a reference document with a distance from the target document in the distributed representations equal to or less than the certain threshold is included, otherwise, it determines that they do not include a document similar in format to the target document.

When the information processing apparatus 100 determines that the obtained reference documents do not include a document similar in format to the target document, the information processing apparatus 100 performs an extraction process 305 of information from the target document. In the extraction process 305, the information processing apparatus 100 performs inference regarding information extraction by inputting the prompt including the instruction for extracting information (character string) corresponding to the item to be specified and the document information of the target document into the large language model to extract the information (character string) corresponding to the item instructed in the target document. In this case, since the documents processed in the past do not include a document similar in format to the target document, the information processing apparatus 100 generates, for example, a prompt with an example of a document that shows how to extract information from a document as an example for few-shot learning and inputs the prompt into the large language model without using the information about the reference documents obtained through the obtaining process 304. Note that although the similarity to the target document is low, the similarity to the target document is high when compared with other documents processed in the past, and therefore, a prompt with information about the reference documents obtained through the obtaining process 304 as examples for few-shot learning may be generated and input into the large language model.

After performing the extraction process 305, the information processing apparatus 100 performs a modification process 306 of the extraction result to modify the extraction result in the extraction process 305 as necessary based on the modification request, or the like from the user. The information processing apparatus 100 presents the extraction result in the extraction process 305 to the user and receives the modification request, or the like from the user for the extraction result presented. For example, assume that the item name different from the item name of the item instructed to be extracted with the prompt leads to “no information” in the extraction result in the extraction process 305, but the information (character string) corresponding to the item is included in the image data (document information) of the target document. Then, if the user who has confirmed the extraction result presented makes a modification request to modify the extraction result of “no information” to the information included in the image data (document information) of the target document, the extraction result is modified to the information specified by the user in accordance with the modification request from the user.

After performing the modification process 306, the information processing apparatus 100 performs the storing process 307 of the document information, the distributed representation, and the extraction result that are related to the target document to store the document information, the distributed representation, and the extraction result that are related to the target document in the database 312 while associating them with each other. The information processing apparatus 100, for example, provides the target document with an identifier (ID) to be uniquely identified and stores the identifier (ID), the document information acquired through the acquisition process 302, the distributed representation obtained through the conversion process 303, and the extraction result modified after the modification process 306 in the database 312 while associating them with each other.

When the information processing apparatus 100 determines that the obtained reference documents include a document similar in format to the target document, the information processing apparatus 100 performs a generation process 308 of a prompt that includes information about the reference documents to generate the prompt to be provided to the large language model in an extraction process 310 described below. The information processing apparatus 100 generates a prompt including an instruction for extracting information (character string) corresponding to the item to be specified from the target document and the document information of the target document with reference to item names and item descriptions 309. The information processing apparatus 100 also generates a prompt including the information (document information and the extraction result) of the reference documents acquired through the obtaining process 304 as examples for few-shot learning. For example, the information processing apparatus 100 generates a prompt with the document information and the extraction result of the reference documents stored in the database 312 incorporated as they are as examples for few-shot learning.

After performing the generation process 308, the information processing apparatus 100 performs the extraction process 310 of information from the target document. In the extraction process 310, the information processing apparatus 100 performs inference regarding information extraction by inputting the prompt generated through the generation process 308 into the large language model to extract the information (character string) corresponding to the item instructed.

After performing the extraction process 310, the information processing apparatus 100 performs the storing process 311 of the document information, the distributed representation, and the extraction result that are related to the target document to store the document information, the distributed representation, and the extraction result that are related to the target document in the database 312 while associating them with each other. The information processing apparatus 100, for example, provides the target document with the identifier (ID) to be uniquely identified and stores the identifier (ID), the document information acquired through the acquisition process 302, the distributed representation obtained through the conversion process 303, and the extraction result in the extraction process 310 in the database 312 while associating them with each other. Here, since the reference documents are obtained from among the documents stored through the storing process 307 in the obtaining process 304, the document information, the distributed representation, and the extraction result that are related to the target document stored through the storing process 307 and the document information, the distributed representation, and the extraction result that are related to the target document stored through the storing process 311 are preferably stored separately in each respective database (or storage area).

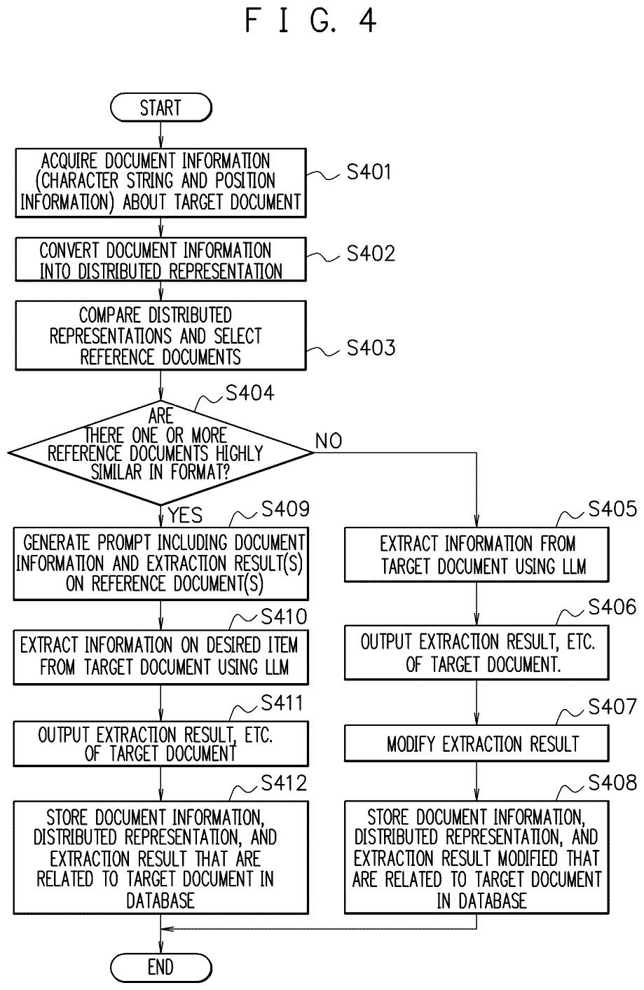

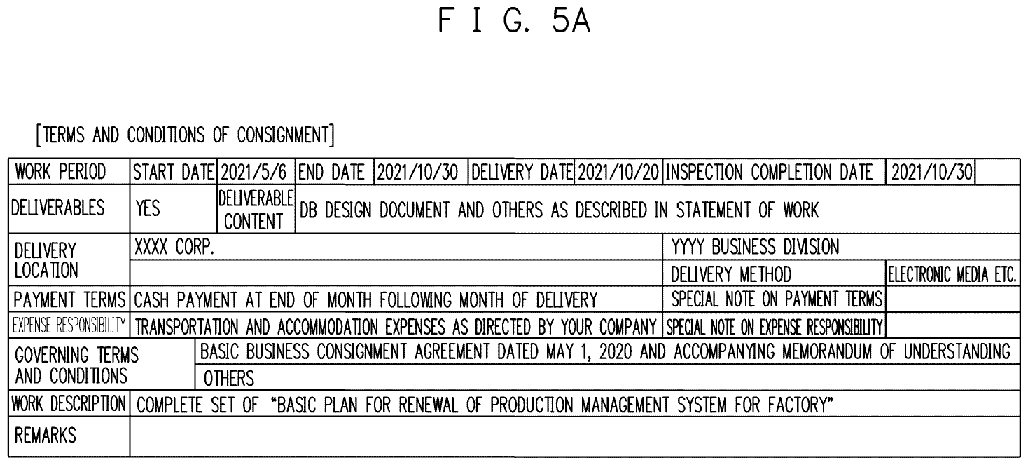

FIG. 4 is a flowchart illustrating an example of processing of the information processing apparatus 100 according to the first embodiment.

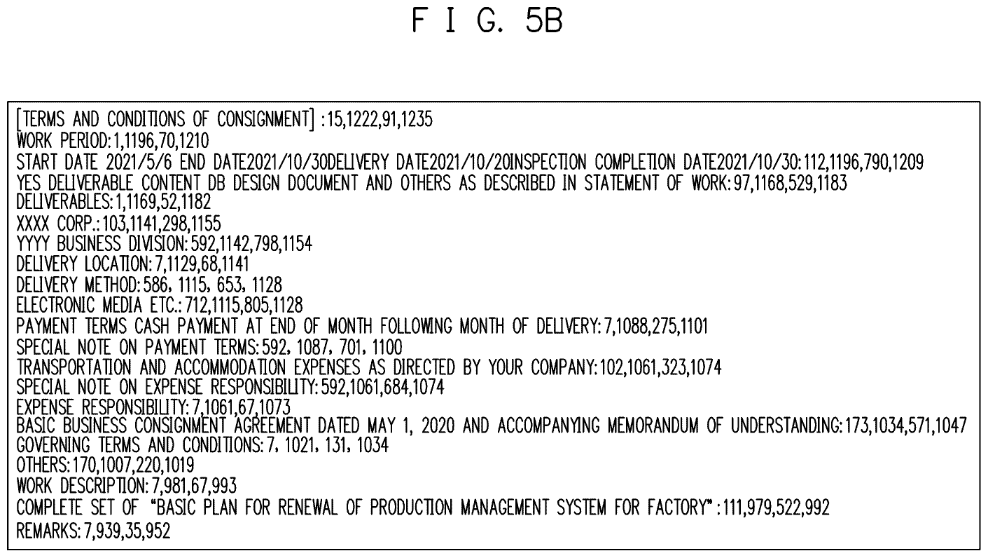

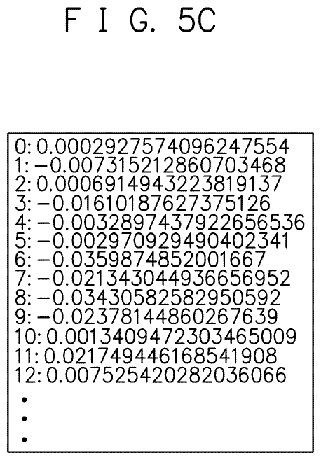

In step S401, the acquisition unit 204 performs optical character recognition on the image data of the document to be processed (target document) 301 to acquire document information (the character string included in the image data and position information of the character string) of the target document. For example, the acquisition unit 204 scans or captures the target document as illustrated in FIG. 5A to acquire the image data. The acquisition unit 204 performs optical character recognition processing on the image data acquired to acquire the document information (character string and position information of the character string) of the target document as illustrated in FIG. 5B. FIG. 5B illustrates, as an example, the document information of the target document in the form of “character string: position information.” The position information of the character string indicates four values of a minimum x-coordinate, a minimum y-coordinate, a maximum x-coordinate and a maximum y-coordinate of the character string in the XY coordinate system with one end point in the document (for example, the upper left point, the lower left point, or the like) as the origin. In the case of a document that includes a table as illustrated in FIG. 5A, the acquisition unit 204 recognizes and excludes the frame lines in the table in the image data of the document to acquire the character string. The acquisition unit 204 may separate areas based on the frame lines of the table recognized to acquire the character string.

In step S402, the conversion unit 205 converts the document information (the combination of character string and position information) of the target document acquired in step S401 into a distributed representation using a pre-trained embedding model or the like. For example, the conversion unit 205 inputs the document information of the target document as illustrated in FIG. 5B into the pre-trained embedding model to convert the document information into the distributed representations (multi-dimensional real-number vectors) as illustrated in FIG. 5C.

In step S403, the selection unit 206 compares the distributed representation of the target document obtained in step S402 and the distributed representations of the documents processed in the past with machine learning (for example, the k-nearest neighbor method) to select documents (reference documents) to be referred to in the process of extracting information from the target document from among the documents processed in the past. For example, the selection unit 206 compares the distributed representation of the target document and the distributed representations of the documents processed in the past that are stored in the storage unit 203 with the modification process performed on the extraction result to obtain a certain number of documents in descending order of similarity in the distributed representations with the target document (in ascending order of distance) from among the documents processed in the past as the reference documents.

In step S404, the instruction generation unit 207 determines whether the reference documents selected in step S403 include a document highly similar in format to the target document or not. The instruction generation unit 207 determines whether a reference document highly similar in format is included or not based on the distance between the distributed representation of the target document and the distributed representations of the reference documents. The instruction generation unit 207 determines, for example, that they are highly similar in format if the distance between the distributed representation of the target document and the distributed representation of the reference document is equal to or less than the certain threshold, otherwise, they are not highly similar in format. When the instruction generation unit 207 determines that the reference documents selected include a document highly similar in format to the target document (YES), the process in step S409 is performed. When the instruction generation unit 207 determines that the reference documents selected do not include a document highly similar in format to the target document (NO), the process in step S405 is performed.

In step S405, which is performed when the instruction generation unit 207 determines that the reference documents selected do not include a document highly similar in format to the target document, the information extraction unit 208 extracts information from the target document using the large language model. Specifically, the information extraction unit 208 performs inference regarding information extraction by inputting the prompt generated by the instruction generation unit 207 including the instruction for extracting information (character string) corresponding to the item to be specified and the document information of the target document into the large language model to extract the information (character string) corresponding to the item instructed from the target document. In this case, for example, a prompt with an example of a document that shows how to extract information from a document as an example for few-shot learning is generated by the instruction generation unit 207 and is input into the large language model.

In step S406, the control unit 201 outputs the extraction result of the information related to the target document obtained in the process in step S405. In addition to the extraction result of the information, the control unit 201 may output the document information, or the like of the target document obtained in step S401.

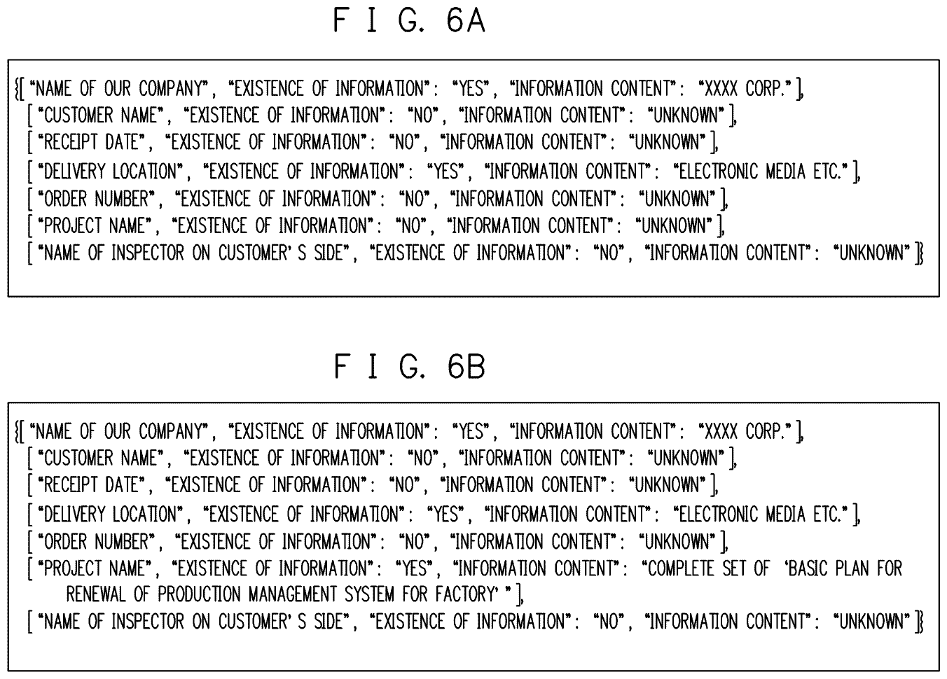

In step S407, the modification unit 209 modifies the extraction result in response to a modification request or the like from the user. For example, if the user who has confirmed the extraction result of the information related to the target document output in step S406 makes a modification request for the extraction result, the modification unit 209 receives the modification request and modifies the extraction result in accordance with the modification request. As an example, assume that the extraction result illustrated in FIG. 6A is obtained in step S406 based on the document information of the target document illustrated in FIG. 5B with respect to the target document illustrated in FIG. 5A. In the example illustrated in FIG. 6A, the existence of information for the item “Project name” indicates “No” and the contents of information indicates “Unknown,” but in the target document illustrated in FIG. 5A, the information provided in the item “Work description” is the information corresponding to the item “Project name.” In this case, if the user makes a modification request to modify it to the contents of the item “Work description” in the target document (a complete set of “Basic Plan for Renewal of Production System for Factory”) as the information corresponding to the item “Project name,” the modification unit 209 modifies the extraction result by modifying the existence of information and the contents of the information for the item “Project name” in the extraction result of the information related to the target document as illustrated in FIG. 6B. Providing this modified extraction result as an example for few-shot learning enables the large language model to learn that the item “Work description” corresponds to the item “Project name” in documents similar to the one illustrated in FIG. 5A. In this way, labeling regarding extraction result can be completed by modifying only part of the item information, enabling labeling with a minimum effort and making it easier compared with normal labeling. In addition, since the extraction result modified can be incorporated without having to input a sentence into a prompt for each processing by providing the extraction result modified to the large language model as an example for few-shot learning with a prompt, information equivalent to tacit knowledge, business knowledge, or the like can be easily and efficiently learned.

In step S408, the control unit 201 stores the document information, the distributed representation and the extraction result that are related to the target document in the database (storage unit 203) while associating them with each other. The control unit 201, for example, provides the target document with the identifier (ID) to be uniquely identified and stores the identifier (ID), the document information acquired in step S401, the distributed representation obtained in step S402 and the extraction result modified after modification in step S407 in the database while associating them with each other. After performing the process in step S408, the information processing apparatus 100 completes the process illustrated in FIG. 4.

In step S409, which is performed when the instruction generation unit 207 determines that the reference documents selected include a document highly similar in format to the target document, the instruction generation unit 207 generates a prompt to be provided to the large language model. The instruction generation unit 207 generates a prompt including information about the reference documents selected in step S403 (document information and extraction results) as well as the instruction for extracting information (character string) corresponding to the item to be specified from the target document and the document information of the target document.

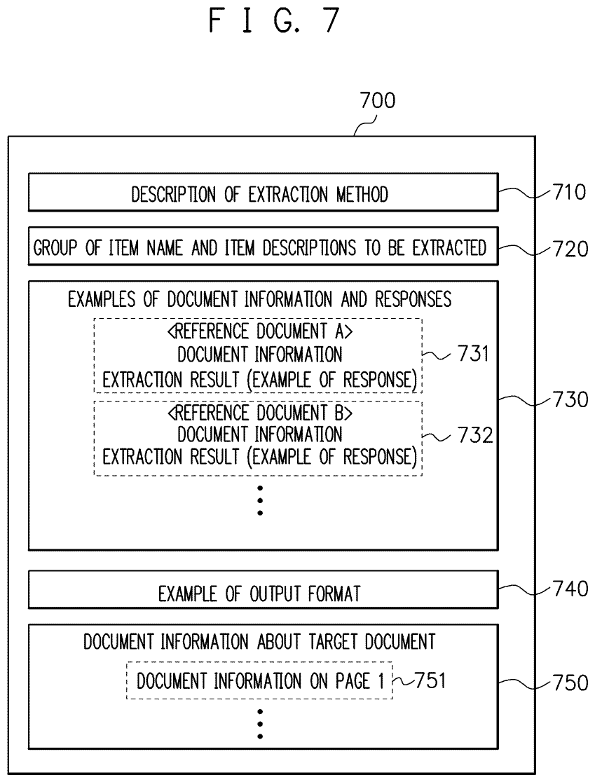

An example of a prompt generated in step S409 is illustrated in FIG. 7. As illustrated in FIG. 7, the prompt 700 includes a description of an extraction method with respect to information (character string) 710, a group of the item names and the item descriptions to be extracted 720, examples of document information and responses 730, an example of an output format 740, and document information of the target document 750. The description of the extraction method 710 is a description of the method of extracting information from the document information of the target document. The group of the item names and the item descriptions to be extracted 720 is a description of the item names and the items with respect to one or more items to be extracted. The descriptions of the items describe, for example, general knowledge (description) that can be commonly used in documents to be processed. Including the descriptions of the items in the prompt enables updating knowledge with respect to the items that the large language model has to common knowledge as well as allowing learning of knowledge with respect to the items that the large language model does not have. Updating to common knowledge and allowing learning of common knowledge enables accurate extraction of character strings corresponding to specified items. The examples of document information and responses 730 are examples (samples) for few-shot learning and include the document information of the reference documents selected in step S403 and extraction results 731 and 732. The example of the output format 740 is an example of the output format when outputting information (character string) corresponding to the item to be extracted as the extraction result. The document information of the target document 750 is the document information of the target document acquired in step S401 and includes document information of each page of the target document 751.

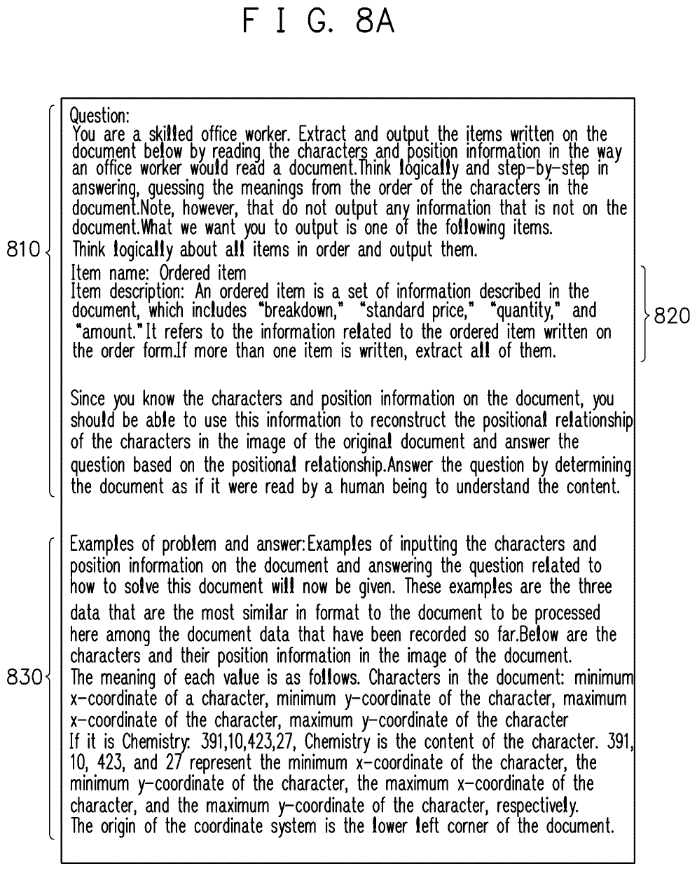

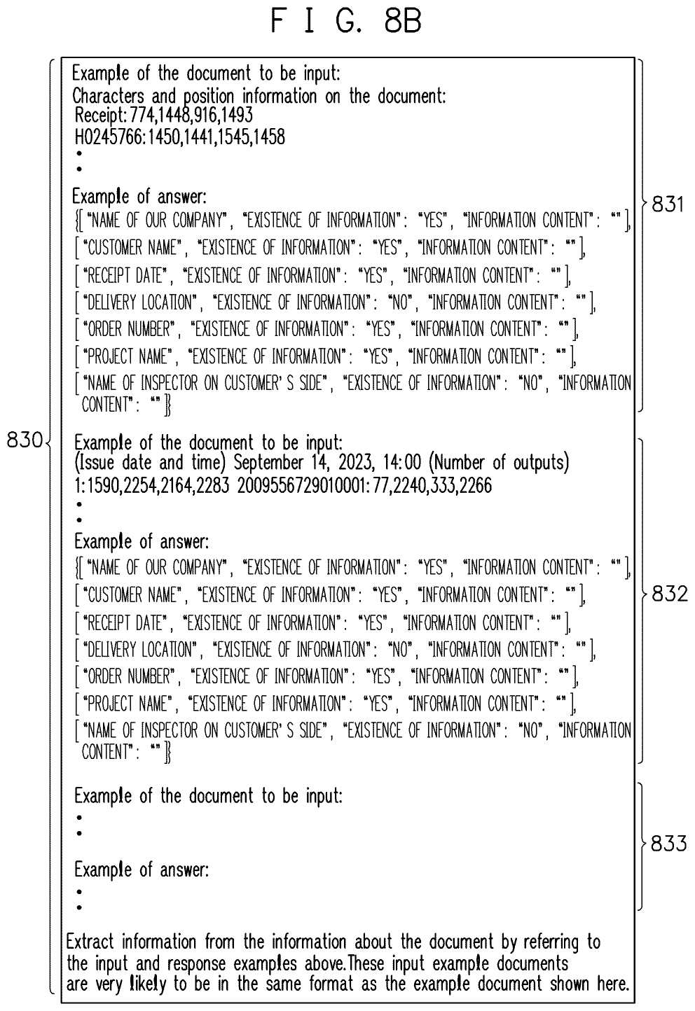

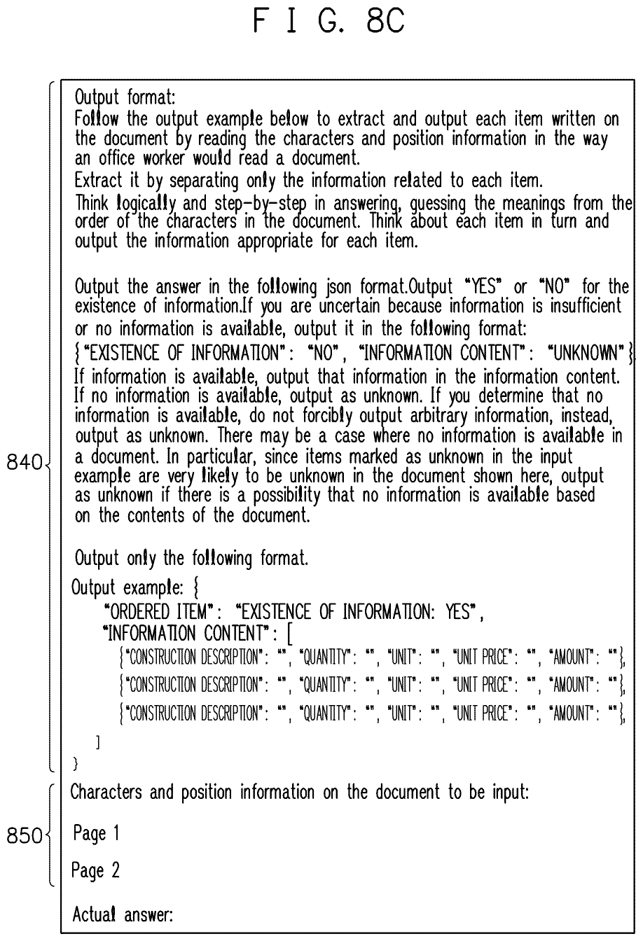

Specific examples of the prompt illustrated in FIG. 7 are illustrated in FIG. 8A to FIG. 8C. The combination of those illustrated in FIG. 8A to FIG. 8C corresponds to one prompt. In FIG. 8A to FIG. 8C, an element 810 corresponds to the description of the extraction method 710, and an element 820 corresponds to the group of the item names and the item descriptions to be extracted 720. An element 830 corresponds to the examples of document information and responses 730 and includes information on three reference documents 831, 832, and 833. An element 840 corresponds to the example of the output format 740, and an element 850 corresponds to the document information of the target document 750.

Turning back to FIG. 4, in step S410, the information extraction unit 208 extracts information from the target document using the large language model. Specifically, the information extraction unit 208 performs inference regarding information extraction by inputting the prompt generated in step S409 including the instruction for extracting information (character string) corresponding to the desired item, the document information of the target document, and the document information and the extraction result of the reference documents into the large language model to extract the information (character string) corresponding to the item instructed from the target document.

In step S411, the control unit 201 outputs the extraction result of the information related to the target document obtained in the process in step S410. In addition to the extraction result of the information, the control unit 201 may output the document information of the target document acquired in step S401 and the similarity (distance) in the distributed representations between the reference documents selected in step S403 and the target document, or the like.

In step S412, the control unit 201 stores the document information, the distributed representation, and the extraction result that are related to the target document in the database (storage unit 203) while associating them with each other. The control unit 201, for example, provides the target document with the identifier (ID) to be uniquely identified and stores the identifier (ID), the document information acquired in step S401, the distributed representation obtained in step S402, and the extraction result obtained in step S410 in the database while associating them with each other. After performing the process in step S412, the information processing apparatus 100 completes the process illustrated in FIG. 4.

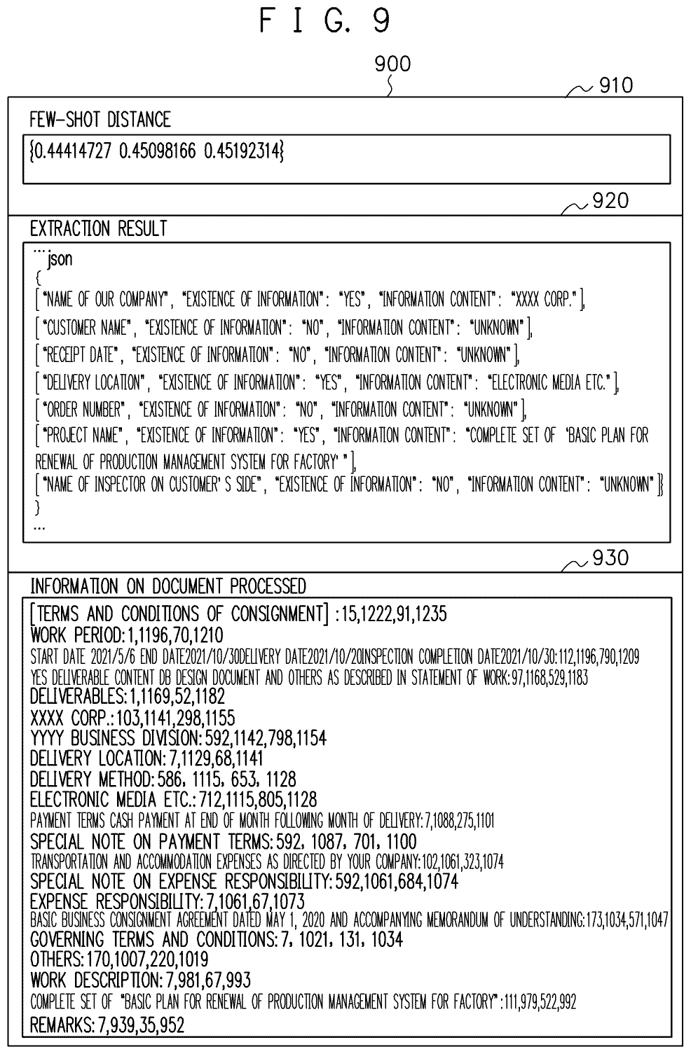

FIG. 9 is a view describing an example of output of a processing result with respect to information extraction from the target document by the information processing apparatus 100 according to the first embodiment. The processing result illustrated in FIG. 9 is displayed to the user by, for example, the output device 105 via the input/output control unit 202. In the processing result 900 illustrated in FIG. 9, the distances between the distributed representations of the reference documents selected from among the documents processed in the past and the distributed representation of the target document are output in a few-shot distance 910. In this example, the distances to the distributed representation of the target document are displayed for three reference documents. Extraction results of the information related to the target document are output in an extraction result 920. The extraction result includes, for example, the item name of the item to be extracted and the existence and contents of the information corresponding to the item, and the like. Document information (character string and position information) of the target document obtained based on the image data of the target document is output in information on processed document 930. The example of output of the processing result illustrated in FIG. 9 is only an example, the output is not limited to this, and other information related to the process of extracting information may be displayed.

According to the first embodiment, the information processing apparatus 100 can extract the information (character string) corresponding to the desired item from the image data of the target document by inputting a prompt including the instruction for extracting the information (character string) corresponding to the specified item and the document information of the target document into the large language model. In addition, by acquiring documents that are similar in format to the target document from among the documents processed in the past as the reference documents, including (incorporating) the information (document information and extraction result) of the reference documents obtained in the past in the prompt as examples for few-shot learning, and inputting the prompt into the large language model, information equivalent to tacit knowledge, business knowledge, or the like can be easily and efficiently learned without having to transcribe everything as sentences, thereby enabling accurate extraction of information (character string) corresponding to the desired item from the image data of the target document.

Note that while the coordinates of the character string in the XY coordinate system with one end point in the document as the origin (minimum and maximum x-coordinates, and minimum and maximum y-coordinates) are used as the position information of the character string, coordinates normalized using a width and a height of the document may be used as the position information of the character string so that the values are within the range of 0 to 1. Using normalized position information increases the probability that documents similar in layout when viewed as an entire page are selected as the reference documents even if the sizes of the documents are not the same, thereby improving the accuracy of selecting the reference documents.

### Second Embodiment

The second embodiment is described.

While in the first embodiment, the reference documents are obtained from among the documents processed in the past based on the distributed representations of the documents, in the second embodiment described below, reference documents are obtained from among documents processed in the past based on, instead of the distributed representations, an overlap ratio (Intersection over Union, IoU) of character string regions between documents. This method is based on the idea that documents with the same layout basically have the same positions of character strings in the documents, with a high overlap ratio (IoU) of character string regions indicating that the documents are similar in format.

Since the hardware configuration of the information processing apparatus 100 according to the second embodiment is the same as the hardware configuration of the information processing apparatus according to the first embodiment illustrated in FIG. 1, the description thereof is omitted.

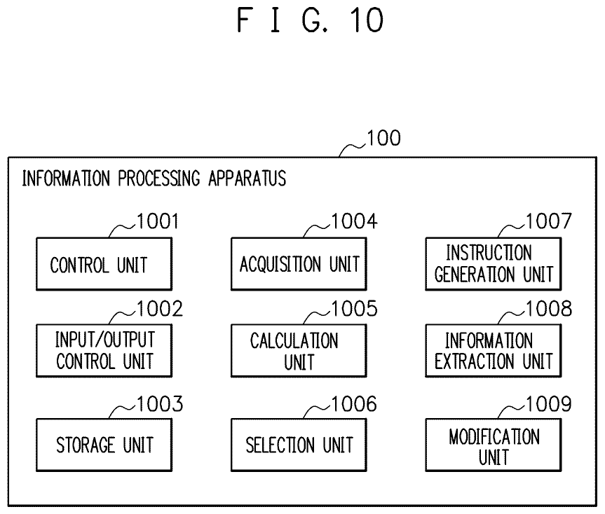

FIG. 10 is a diagram illustrating an example of a functional configuration of the information processing apparatus 100 according to the second embodiment. The information processing apparatus 100 according to the second embodiment includes a control unit 1001, an input/output control unit 1002, a storage unit 1003, an acquisition unit 1004, a calculation unit 1005, a selection unit 1006, an instruction generation unit 1007, an information extraction unit 1008, and a modification unit 1009.

The control unit 1001 is responsible for controlling each component of the information processing apparatus 100. The input/output control unit 1002 performs various types of processing related to the presentation of various types of information to a user and the reception of information input (for example, an instruction or the like) from the user. For example, the input/output control unit 1002 may perform processing related to the presentation of a UI or processing related to the reception of input via the UI. Thus, the information processing apparatus 100 can recognize the instruction from the user and present a result of processing in accordance with the instruction to the user.

The storage unit 1003 schematically represents a storage area for storing various types of data, various types of programs, and the like. For example, the storage unit 1003 may store data or a program for each component of the information processing apparatus 100 to perform a process. The storage unit 1003 may store a pre-trained model that has been trained by machine learning (deep learning or hierarchical learning) that is used for inference regarding information extraction. The storage unit 1003 may store document information related to a document and the extraction result of information on a document.

The acquisition unit 1004 acquires image data of a document by optically scanning or capturing the document. The acquisition unit 1004 also performs optical character recognition processing on the acquired image data of the document to extract and acquire the document information related to the document. The document information includes a character string included in the image data of the document and position information indicating the position of the character string in the document. The acquisition unit 1004 may receive and acquire the image data of the document acquired by externally scanning or capturing the document in advance as input without scanning or capturing the document. The acquisition unit 1004 may acquire the document information by receiving the character string included in the document and its position information that are acquired as a result of an external optical character recognition processing as input.

The calculation unit 1005 calculates the overlap ratio (IoU) of the character string regions (character regions) between a document to be processed (target document) and documents processed in the past. The overlap ratio (IoU) of the character regions is calculated as {(area of regions overlapping in character region A and character region B)/(total area of the two regions of character region A and character region B)}, where character region A is the character region to be calculated in the target document and character region B is the character region to be calculated in the document processed in the past, and its value is within the range of 0 to 1. In the present embodiment, the calculation unit 1005 defines the overlap ratio (IoU) of bounding boxes (rectangles) surrounding the character strings that are identified by the position information of the character strings in the document information as the overlap ratio (IoU) of the character string regions (character regions). The calculation unit 1005 calculates an average overlap ratio (average IoU) on a page-by-page basis for the documents. The calculation unit 1005 may calculate the average overlap ratio (average IoU) on a document-by-document basis. A detailed description of the average overlap ratio (average IoU) is described below.

The selection unit 1006 selects documents (reference documents) to be referred to in the process of extracting information from the document to be processed (target document) from among the documents processed in the past for which the document information or the like related to the documents is stored in the storage unit 1003 based on the overlap ratio (IoU) of the character string regions (character regions). Specifically, the selection unit 1006 selects a certain number of documents as the reference documents from among the documents processed in the past for which the average overlap ratio (average IoU) is equal to or higher than a certain threshold in descending order of average overlap ratio (average IoU) based on the average overlap ratio (average IoU) obtained by the calculation in the calculation unit 1005.

Also in the present embodiment, the instruction generation unit 1007 generates an instruction for extracting information (character string) from the target document and inputs the instruction into the information extraction unit 1008, and the information extraction unit 1008 uses a large language model (LLM) to extract the information (character string) in accordance with the input instruction.

The instruction generation unit 1007 generates a prompt including the instruction for extracting information (character string) corresponding to a desired item from the target document and the document information of the target document and inputs the prompt into the information extraction unit 1008. When any one of the reference documents is selected by the selection unit 1006 as a document with high similarity to the target document, the instruction generation unit 1007 generates a prompt with the document information and the extraction result related to the reference document as examples for few-shot learning and inputs the prompt into the information extraction unit 1008. In this way, by providing information about the reference documents that have a high similarity to the target document (document information and extraction result) to the large language model as examples for few-shot learning, knowledge, and the like equivalent to tacit knowledge, business knowledge, or the like can be easily and efficiently learned to extract information (character strings) corresponding to the desired item with high accuracy.

The information extraction unit 1008 performs inference with the large language model based on the prompt generated and input by the instruction generation unit 1007 to extract information (character string) corresponding to the item instructed to be extracted by the prompt from the image data of the target document. The modification unit 1009 receives a modification request from the user for the extraction result of information related to the target document by the information extraction unit 1008 and modifies the extraction result in accordance with the modification request. The extraction result of the information related to the target document extracted by the information extraction unit 1008 (or the modified extraction result if modification is performed by the modification unit 1009) is stored in the storage unit 1003 while being associated with the document information acquired by the acquisition unit 1004.

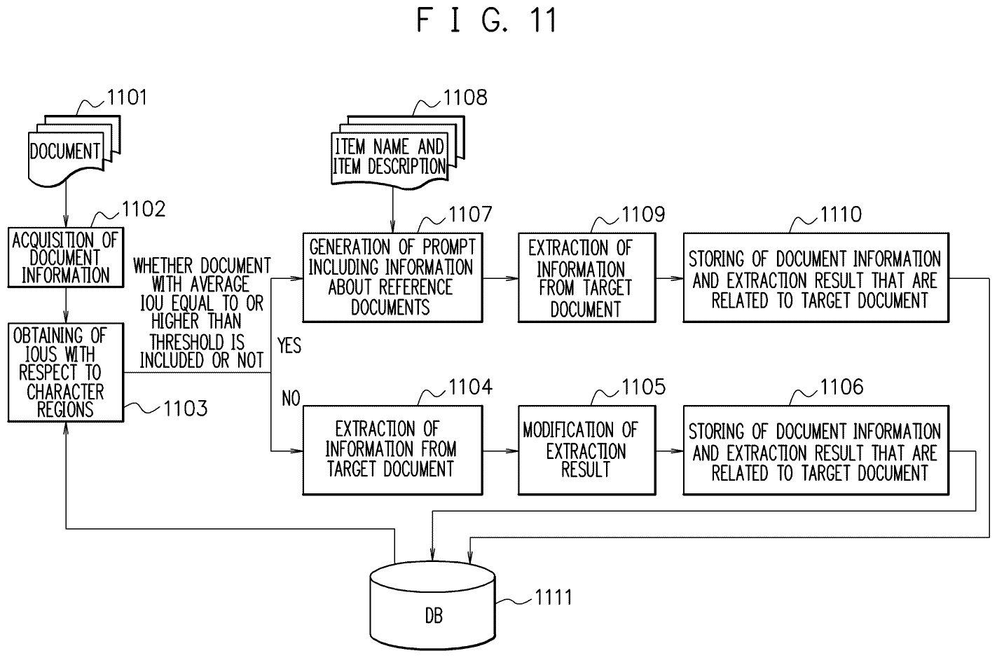

With reference to FIG. 11, the processing in the information processing apparatus 100 according to the second embodiment is described. FIG. 11 is a view describing an example of processing of the information processing apparatus 100 according to the second embodiment.

The information processing apparatus 100 performs an acquisition process 1102 of document information to acquire document information (the character string included in the image data and position information of the character string) from the image data of a document to be processed (target document) 1101.

Next, the information processing apparatus 100 performs an acquisition process 1103 of the IoU with respect to the character regions, and calculates and obtains the overlap ratio (IoU) of the character string regions (character regions) between the document to be processed (target document) and the documents processed in the past that are stored in a database 1111. The information processing apparatus 100 also calculates and obtains the average overlap ratio (average IoU) based on the calculated overlap ratios (IoUs) of the character string regions (character regions).

After obtaining the average overlap ratio (average IoU) in the acquisition process 1103, the information processing apparatus 100 determines whether the documents processed in the past include a document for which the obtained average overlap ratio (average IoU) is equal to or higher than the threshold or not.

When the information processing apparatus 100 determines that no document with an average overlap ratio (average IoU) equal to or higher than the threshold is included, the information processing apparatus 100 performs an extraction process 1104 of information from the target document. In the extraction process 1104, the information processing apparatus 100 performs inference regarding information extraction by inputting the prompt including the instruction for extracting information (character string) corresponding to the item to be specified and the document information of the target document into the large language model to extract the information (character string) corresponding to the item instructed in the target document. In this case, since the documents processed in the past do not include a document similar in layout to the target document for which the average overlap ratio (average IoU) is equal to or higher than the threshold, the information processing apparatus 100 generates, for example, a prompt with an example of a document that shows how to extract information from a document as an example for few-shot learning and inputs the prompt into the large language model.

After performing the extraction process 1104, the information processing apparatus 100 performs a modification process 1105 of the extraction result to modify the extraction result in the extraction process 1104 as necessary based on the modification request or the like from the user. In the same manner as the modification process 306 in the first embodiment illustrated in FIG. 3, the information processing apparatus 100 presents the extraction result in the extraction process 1104 to the user and receives the modification request or the like from the user for the extraction result presented, and modifies the extraction result to the information specified by the user in accordance with the modification request from the user.

After performing the modification process 1105, the information processing apparatus 100 performs a storing process 1106 of the document information and the extraction result that are related to the target document to store the document information and the extraction result that are related to the target document in the database 1111 while associating them with each other. The information processing apparatus 100, for example, provides the target document with an identifier (ID) to be uniquely identified and stores the identifier (ID), the document information acquired through the acquisition process 1102, and the extraction result modified after the modification process 1105 in the database 1111 while associating them with each other.

When the information processing apparatus 100 determines that documents with an average overlap ratio (average IoU) equal to or higher than the threshold are included, it obtains a certain number of documents as the reference documents from among the documents processed in the past in descending order of average overlap ratio (average IoU), performs a generation process 1107 of a prompt including the information about the reference documents, and generates a prompt to be provided to the large language model in an extraction process 1109 described below. The information processing apparatus 100 generates a prompt including an instruction for extracting information (character string) corresponding to the item to be specified from the target document and the document information of the target document with reference to item name and item descriptions 1108. The information processing apparatus 100 also generates a prompt including the information (document information and the extraction result) of the reference documents acquired as examples for few-shot learning. For example, the information processing apparatus 100 generates a prompt with the document information and the extraction results of the reference documents stored in the database 1111 incorporated as they are as examples for few-shot learning. The documents obtained as reference documents from among the documents processed in the past may be one document or a plurality of documents.

After performing the generation process 1107, the information processing apparatus 100 performs the extraction process 1109 of information from the target document. In the extraction process 1109, the information processing apparatus 100 performs inference regarding information extraction by inputting the prompt generated through the generation process 1107 into the large language model to extract the information (character string) corresponding to the item instructed.

After performing the extraction process 1109, the information processing apparatus 100 performs a storing process 1110 of the document information and the extraction result that are related to the target document to store the document information and the extraction result that are related to the target document in the database 1111 while associating them with each other. The information processing apparatus 100, for example, provides the target document with the identifier (ID) to be uniquely identified and stores the identifier (ID), the document information acquired through the acquisition process 1102, and the extraction result through the extraction process 1109 in the database 1111 while associating them with each other.

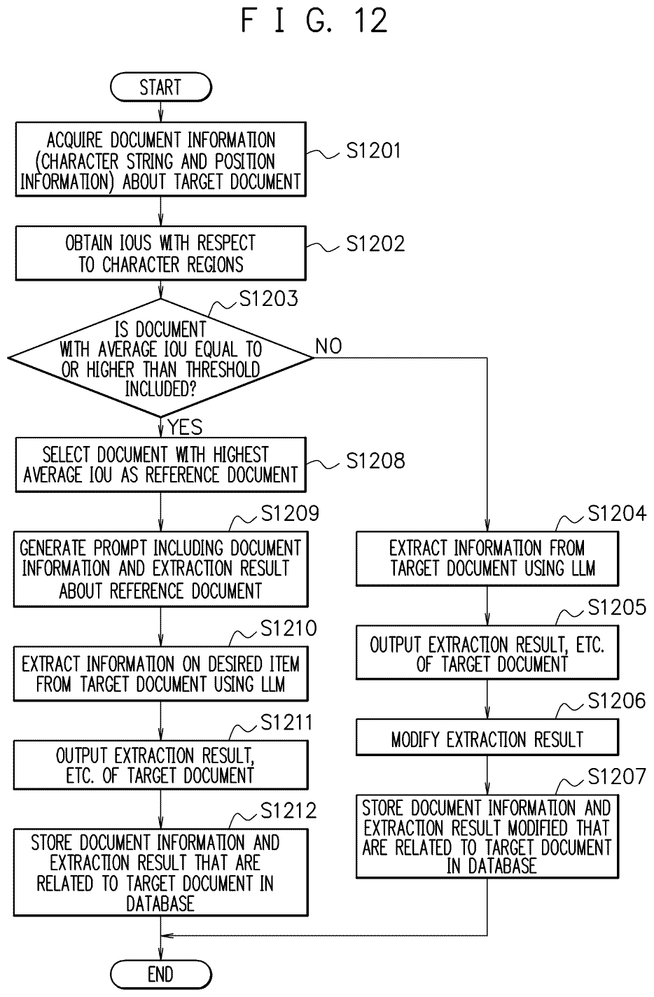

FIG. 12 is a flowchart illustrating an example of processing of the information processing apparatus 100 according to the second embodiment.

In step S1201, the acquisition unit 1004 acquires the image data by scanning or capturing the document to be processed (target document) and performs optical character recognition processing on the acquired image data to acquire document information (the character string included in the image data and position information of the character string) of the target document. As the position information of a character string, for example, four values of a minimum x-coordinate, a minimum y-coordinate, a maximum x-coordinate and a maximum y-coordinate of the character string in the XY coordinate system with one end point in the document (for example, the upper left point, the lower left point, or the like) as the origin are acquired. The rectangle defined by these four values is the bounding box that indicates the character string region (character region). In the optical character recognition processing, information indicating a width (length in the horizontal direction) and a height (length in the vertical direction), which represent the size of the document (corresponding to the maximum value of the x-coordinate and the maximum value of the y-coordinate that are possible in the document) is acquired. The position information of the character string is normalized using the width and the height of the document acquired so that the values are within the range of 0 to 1. Using normalized position information enables a higher value as the average IoU to be obtained for documents similar in layout when viewed as an entire page even if the sizes of the documents are not the same, thereby improving the accuracy of selecting the documents to be the reference documents.

In step S1202, the calculation unit 1005 calculates and obtains the overlap ratio (IoU) with respect to the character string regions (character regions) between the target document acquired in step S1201 and the documents processed in the past. The calculation unit 1005 also calculates and obtains the average overlap ratio (average IoU) based on the calculated overlap ratios (IoUs) of the character string regions (character regions).

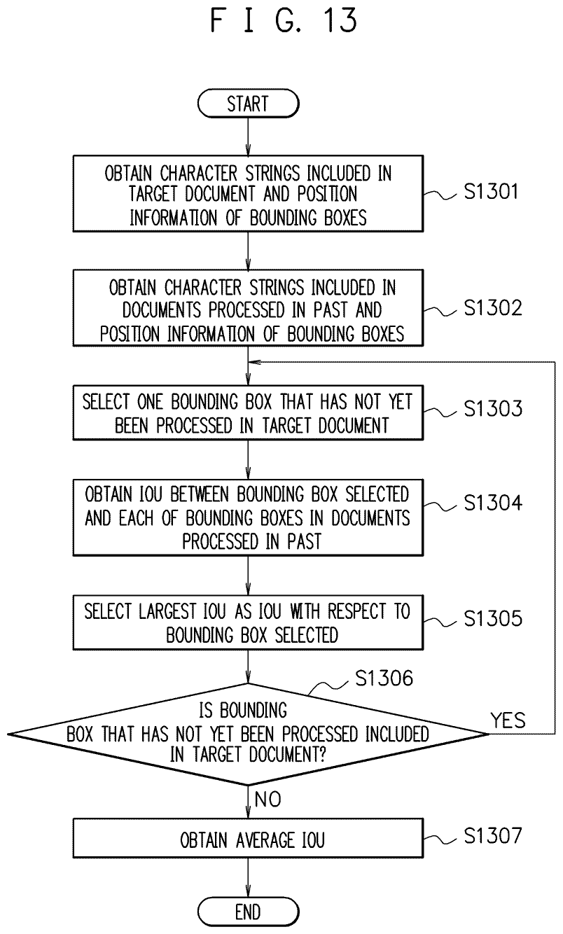

With reference to FIG. 13, the acquisition process of the overlap ratio (IoU) of the character string regions (character regions) is described. FIG. 13 is a flowchart illustrating an example of the acquisition process of the overlap ratio (IoU) of the character string regions (character regions). FIG. 13 illustrates an example of acquiring the overlap ratio (IoU) of the character string regions (character regions) on corresponding pages between the target document and the documents processed in the past. In the following description with respect to FIG. 13, the “target document” refers to a page to be processed in the target document, and the “documents in the past” refers to pages corresponding to the page to be processed in the target document in the documents processed in the past.

In step S1301, the calculation unit 1005 obtains the character strings included in the target document and the position information of the bounding boxes surrounding the character strings based on the document information of the target document acquired in step S1201 in FIG. 12. As described above, the bounding box indicating the character region is a rectangle identified by the values of the position information of the character string, and thus the position information of the bounding box and the position information of the character string are the same information (the same is true below). In other words, in the process of step S1301, the calculation unit 1005 obtains the document information (character strings and position information of the character strings) with respect to the page to be processed from the document information (character strings and position information of the character strings) of the target document acquired in step S1201 in FIG. 12.

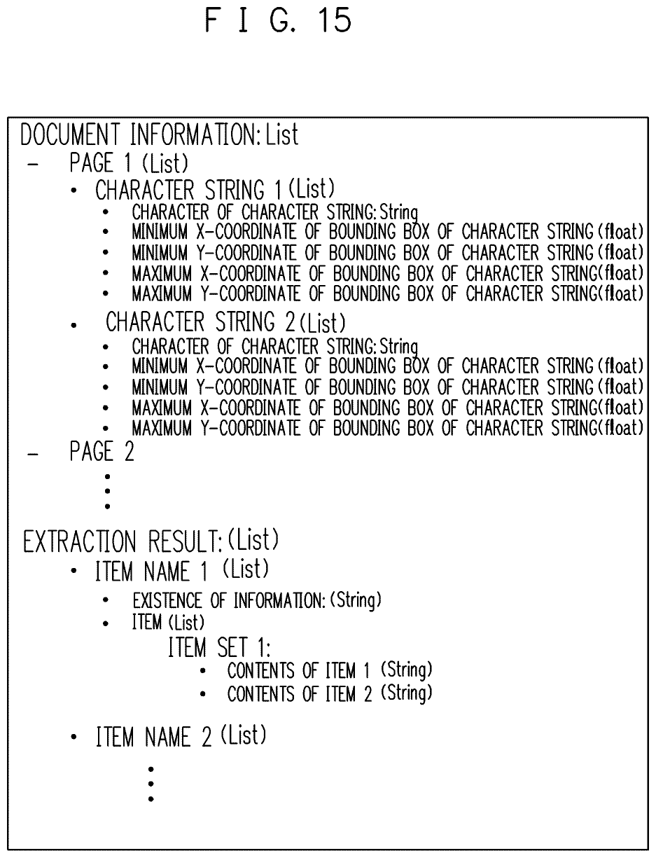

In step S1302, the calculation unit 1005 obtains the character strings included in each of the documents in the past and the position information of the bounding boxes surrounding the character strings based on the information about the documents processed in the past that is stored in the storage unit 1003. FIG. 15 is a view describing the information about the documents processed in the past (documents in the past) that is stored in the storage unit 1003. The information about the documents processed in the past is stored in json format as illustrated, for example, in FIG. 15. The character string and the position information of the bounding box surrounding the character string (position information of the character string) are stored on a page-by-page basis for each of the character strings included in a page. The position information of the bounding box is normalized so that the coordinates are between 0 and 1 based on the height and the width of the document (the vertical and horizontal sizes of the image data). As a result of the extraction, the item name and one or more contents of item corresponding to the item name are stored.

The order of performing the processes in step S1301 and step S1302 described above is arbitrary, and the process in step S1301 may be performed after the process in step S1302 is performed.

In step S1303, the calculation unit 1005 selects one bounding box that has not yet been processed from among the bounding boxes in the target document.

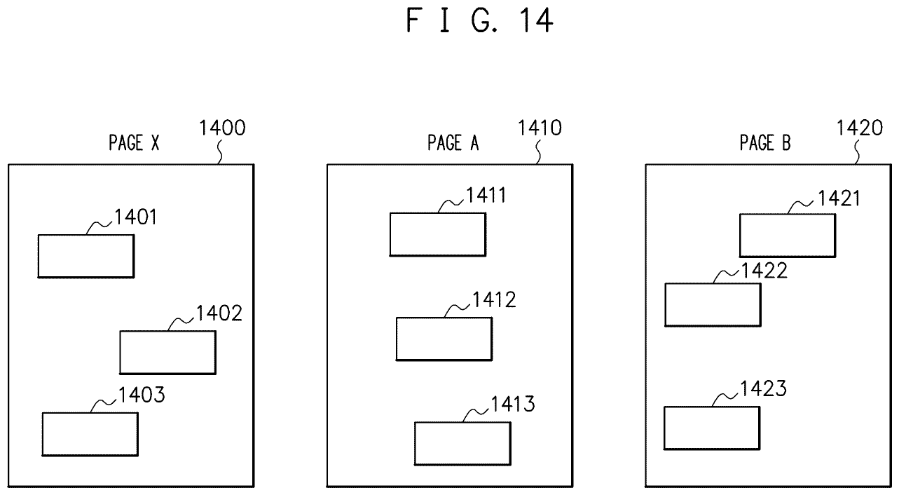

Next, in step S1304, the calculation unit 1005 calculates and obtains the overlap ratio (IoU) between the bounding box selected in step S1303 and each of the bounding boxes in the documents in the past. For example, assume that page X 1400 illustrated in FIG. 14 is the page to be processed in the target document, page A 1410 is the page corresponding to the page to be processed in the target document in document A that has been processed in the past, and page B 1420 is the page corresponding to the page to be processed in the target document in document B that has been processed in the past. Assume that the bounding box 1401 on page X 1400 is selected in step S1303 described above. In this case, in step S1304, the calculation unit 1005 obtains the overlap ratio (IoU) between the bounding box 1401 and the bounding box 1411 on page A 1410 based on the position information of the bounding box 1401 and the position information of the bounding box 1411. In the same way, the calculation unit 1005 obtains the overlap ratio (IoU) between the bounding box 1401 and other bounding boxes on page A 1410, in other words, the overlap ratio (IoU) between the bounding box 1401 and the bounding box 1412, as well as the overlap ratio (IoU) between the bounding box 1401 and the bounding box 1413. The calculation unit 1005 obtains the overlap ratio (IoU) between the bounding box 1401 and the bounding box 1421 on page B 1420 based on the position information of the bounding box 1401 and the position information of the bounding box 1421. In the same way, the calculation unit 1005 obtains the overlap ratio (IoU) between the bounding box 1401 and other bounding boxes on page B 1420, in other words, the overlap ratio (IoU) between the bounding box 1401 and the bounding box 1422, as well as the overlap ratio (IoU) between the bounding box 1401 and the bounding box 1423. Similar processes are performed for other documents in the past. In other words, the process of step S1304 described above is performed for each of the documents in the past.

In step S1305, the calculation unit 1005 selects the largest overlap ratio (IoU) as the overlap ratio (IoU) with respect to the bounding box selected in step S1303 for each of the documents in the past. For example, in the example illustrated in FIG. 14, the largest overlap ratio (IoU) from among the overlap ratios (IoUs) between the bounding box 1401 on page X 1400 and the bounding boxes 1411, 1412, and 1413 on page A 1410 is selected as the overlap ratio (IoU) with respect to the bounding box 1401 in document in the past A. The largest overlap ratio (IoU) from among the overlap ratios (IoUs) between the bounding box 1401 on page X 1400 and the bounding boxes 1421, 1422, and 1423 on page B 1420 is also selected as the overlap ratio (IoU) with respect to the bounding box 1401 in document in the past B. Similar processes are performed for other documents in the past. In other words, the process of step S1305 described above is performed for each of the documents in the past. If the largest overlap ratio (IoU) is 0, in other words, no bounding box that overlaps the bounding box selected in step S1303 is found on the page in the document in the past, the overlap ratio (IoU) with respect to the selected bounding box is to be 0.

Next, in step S1306, the calculation unit 1005 determines whether a bounding box that has not yet been processed is included in the target document or not. If the calculation unit 1005 determines that a bounding box that has not yet been processed is included in the target document (YES), the flow returns to step S1303 to perform the processes from step S1303 and onward again. If the calculation unit 1005 determines that no bounding box that has not yet been processed is included in the target document, in other words, all of the bounding boxes have been processed in step S1303 and onward (NO), the process in step S1307 is performed.

In step S1307, the calculation unit 1005 calculates and obtains the average overlap ratio (average IoU), which is the average value of the selected overlap ratios (IoUs), for each of the documents in the past based on the overlap ratio (IoU) selected for each of the bounding boxes in the target document in step S1305. For example, in the example illustrated in FIG. 14, if the overlap ratios (IoUs) with respect to bounding boxes 1401, 1402, and 1403 in document in the past A are a, b, and c, respectively, (a+b+c)/3 is to be the average overlap ratio (average IoU) for document in the past A (in detail, the page in document in the past A corresponding to the page to be processed in the target document). Similar processes are performed for other documents in the past. In other words, the process of step S1307 described above is performed for each of the documents in the past.

The calculation unit 1005 obtains the average overlap ratio (average IoU) of the pages in the document in the past that correspond to the page to be processed in the target document as described above and calculates the average value of the average overlap ratio (average IoU) of each of the pages in the document in the past to obtain the average overlap ratio (average IoU) for the entire document in the past. When obtaining the average overlap ratio (average IoU) for the entire document in the past, if the document in the past does not include a page corresponding to the page to be processed in the target document, the page is to be excluded from a target for calculation of the average. This process is performed for each of the documents processed in the past. In this way, the calculation unit 1005 obtains the average overlap ratio (average IoU) for each of the documents processed in the past.

In the above description, while the average overlap ratio (average IoU) for the entire document is obtained for each of the documents processed in the past, if the processes from step S1203 and onward in the flowchart illustrated in FIG. 12 are performed on a page-by-page basis instead of a document-by-document basis, the average overlap ratio (average IoU) on a page-by-page basis may be obtained for each of the documents processed in the past. While the average overlap ratio (average IoU) is obtained by comparing the page to be processed in the target document and the page in the document in the past that corresponds to the page to be processed in the target document, the average overlap ratio (average IoU) may be obtained by comparing the page to be processed with each of the pages in the document in the past. Since comparing to the page in the document in the past that corresponds to the page to be processed in the target document can reduce calculation time and improve accuracy compared to comparing to each of the pages in the document in the past, selection of whether to compare to the page in the document in the past that corresponds to the page to be processed in the target document or to each of the pages in the document in the past may be made as appropriate depending on, for example, the time and load required for the processing, accuracy, or the like.

Turning back to FIG. 12, in step S1203, the instruction generation unit 1007 determines whether the documents processed in the past include a document for which the average overlap ratio (average IoU) is equal to or higher than the threshold or not based on the average overlap ratio (average IoU) for each of the documents processed in the past that is obtained in step S1202. If the instruction generation unit 1007 determines that the documents processed in the past include a document for which the average overlap ratio (average IoU) is equal to or higher than the threshold (YES), the process in step S1208 is performed. If the instruction generation unit 1007 determines that the documents processed in the past do not include a document for which the average overlap ratio (average IoU) is equal to or higher than the threshold (NO), the process in step S1204 is performed.

In step S1204, which is performed when the instruction generation unit 1007 determines that the documents processed in the past do not include a document for which the average overlap ratio (average IoU) is equal to or higher than the threshold, the information extraction unit 1008 extracts information from the target document using the large language model. Specifically, the information extraction unit 1008 performs inference regarding information extraction by inputting the prompt generated by the instruction generation unit 1007 including the instruction for extracting information (character string) corresponding to the item to be specified and the document information of the target document into the large language model to extract the information (character string) corresponding to the item instructed from the target document. In this case, for example, a prompt with an example of a document that shows how to extract information from a document as an example for few-shot learning is generated by the instruction generation unit 1007 and is input into the large language model.

In step S1205, the control unit 1001 outputs the extraction result of the information related to the target document obtained in the process in step S1204. Note that in addition to the extraction result of the information, the control unit 1001 may output the document information or the like of the target document obtained in step S1201.

In step S1206, the modification unit 1009 modifies the extraction result in response to the modification request or the like from the user in a manner similar to the process in step S407 in the first embodiment illustrated in FIG. 4. For example, if the user who has confirmed the extraction result of the information related to the target document output in step S1205 makes a modification request for the extraction result, the modification unit 1009 receives the modification request and modifies the extraction result in accordance with the modification request.

In step S1207, the control unit 1001 stores the document information and the extraction result that are related to the target document in the database (storage unit 1003) while associating them with each other. The control unit 1001, for example, provides the target document with the identifier (ID) to be uniquely identified and stores the identifier (ID), the document information acquired in step S1201, and the extraction result modified after modification in step S1206 in the database while associating them with each other. After performing the process in step S1207, the information processing apparatus 100 completes the process illustrated in FIG. 12.

In step S1208, which is performed when the instruction generation unit 1007 determines that the documents processed in the past include a document for which the average overlap ratio (average IoU) is equal to or higher than the threshold, the selection unit 1006 selects the document with the highest average overlap ratio (average IoU) from among the documents processed in the past as the reference document. Note that in this example, while the document with the highest average overlap ratio (average IoU) is selected as the reference document, a plurality of documents may be selected in descending order of average overlap ratio (average IoU).

In step S1209, the instruction generation unit 1007 generates a prompt to be provided to the large language model. The instruction generation unit 1007 generates a prompt including information about the reference document selected in step S1208 (document information and extraction result) as well as the instruction for extracting information (character string) corresponding to the item to be specified from the target document and the document information of the target document. Since the prompt generated in step S1209 is similar to the prompt generated in step S409 in the first embodiment illustrated in FIG. 4, the description thereof is omitted.

In step S1210, the information extraction unit 1008 extracts information from the target document using the large language model. Specifically, the information extraction unit 1008 performs inference regarding information extraction by inputting the prompt generated in step S1209 including the instruction for extracting information (character string) corresponding to the desired item, the document information of the target document, the document information and the extraction result of the reference document into the large language model to extract the information (character string) corresponding to the item instructed from the target document.

In step S1211, the control unit 1001 outputs the extraction result of the information related to the target document obtained in the process in step S1210. In addition to the extraction result of the information, the control unit 1001 may output the document information of the target document, the average IoU of the document processed in the past selected as the reference document, or the like.

In step S1212, the control unit 1001 stores the document information and the extraction result that are related to the target document in the database (storage unit 1003) while associating them with each other. The control unit 1001, for example, provides the target document with the identifier (ID) to be uniquely identified and stores the identifier (ID), the document information acquired in step S1201, and the extraction result obtained in step S1210 in the database while associating them with each other. After performing the process in step S1212, the information processing apparatus 100 completes the process illustrated in FIG. 12.

According to the second embodiment, the information processing apparatus 100 can extract the information (character string) corresponding to the desired item from the image data of the target document by inputting the prompt including the instruction for extracting the information (character string) corresponding to the specified item and the document information of the target document into the large language model. In addition, by obtaining the document that is similar in layout to the target document from among the documents processed in the past as the reference document based on the average overlap ratio (average IoU) of the character string regions between the target document and the documents processed in the past, including (incorporating) the information (document information and extraction result) of the reference document obtained in the past in the prompt as examples for few-shot learning, and inputting the prompt into the large language model, information equivalent to tacit knowledge, business knowledge, or the like can be easily and efficiently learned without having to transcribe everything as sentences, thereby enabling accurate extraction of information (character string) corresponding to the desired item from the image data of the target document.

### Third Embodiment

The third embodiment is described.

Since the hardware configuration of the information processing apparatus 100 according to the third embodiment is the same as the hardware configuration of the information processing apparatus according to the first embodiment illustrated in FIG. 1, the description thereof is omitted.

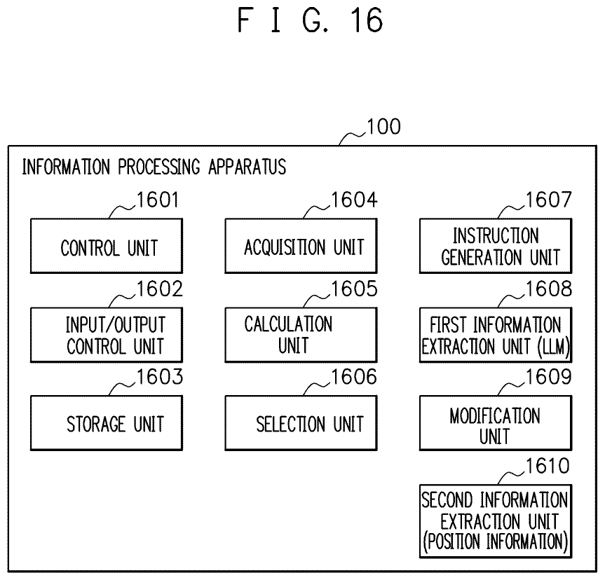

FIG. 16 is a diagram illustrating an example of a functional configuration of the information processing apparatus 100 according to the third embodiment. The information processing apparatus 100 includes a control unit 1601, an input/output control unit 1602, a storage unit 1603, an acquisition unit 1604, a calculation unit 1605, a selection unit 1606, an instruction generation unit 1607, a first information extraction unit 1608, a modification unit 1609, and a second information extraction unit 1610.

The control unit 1601 is responsible for controlling each component of the information processing apparatus 100. The input/output control unit 1602 performs various types of processing related to the presentation of various types of information to a user and the reception of information input (for example, an instruction or the like) from the user. For example, the input/output control unit 1602 may perform processing related to the presentation of a UI or processing related to the reception of input via the UI. Thus, the information processing apparatus 100 can recognize the instruction from the user and present a result of processing in accordance with the instruction to the user.

The storage unit 1603 schematically represents a storage area for storing various types of data, various types of programs, and the like. For example, the storage unit 1603 may store data or a program for each component of the information processing apparatus 100 to perform a process. The storage unit 1603 may store a pre-trained model that has been trained by machine learning (deep learning or hierarchical learning) that is used for inference regarding information extraction. The storage unit 1603 may store various types of information related to documents such as document information or an extraction result of information.

In the third embodiment, document information is each of an item name corresponding to an item to be extracted (extraction target item), contents of an item corresponding to the item name (item contents), and position information with respect to each of the item name and the item contents that are extracted from a document based on the extraction target item, associated with the extraction target item. The position information is information indicating the position in the document of a character string that indicates the item name or the item contents.

The acquisition unit 1604 acquires image data of a document by optically scanning or capturing the document. The acquisition unit 1604 also performs optical character recognition processing on the acquired image data of the document to acquire a character string included in the image data of the document and the position information with respect to the character string. The acquisition unit 1604 may receive and acquire the image data of the document acquired by externally scanning or capturing the document in advance as input without scanning or capturing the document. The acquisition unit 1604 may receive and acquire the character string included in the document and its position information that are acquired as a result of an external optical character recognition processing as input.

The calculation unit 1605 calculates an overlap ratio (IoU) of character string regions (character regions) between a document to be processed (target document) and documents processed in the past. In the present embodiment, the calculation unit 1605 defines the overlap ratio (IoU) of bounding boxes (rectangles) surrounding the character strings that are identified by the position information of the character strings in the document information as the overlap ratio (IoU) of the character string regions (character regions). The calculation unit 1605 calculates an average overlap ratio (average IoU) on a page-by-page basis for the documents. The calculation unit 1605 may calculate the average overlap ratio (average IoU) on a document-by-document basis.

The selection unit 1606 selects a document (reference document) to be referred to in the process of extracting information from the document to be processed (target document) from among the documents processed in the past for which the document information or the like related to the document is stored in the storage unit 1603 based on the overlap ratio (IoU) of the character string regions (character regions). Specifically, the selection unit 1606 selects a document as the reference document for which the average overlap ratio (average IoU) is equal to or higher than a certain threshold and the average overlap ratio (average IoU) is the highest based on the average overlap ratio (average IoU) obtained by the calculation in the calculation unit 1605.

The information processing apparatus 100 according to the present embodiment can extract information related to the extraction target item instructed from the image data of the document using a large language model by the instruction generation unit 1607 and the first information extraction unit 1608. For example, the instruction generation unit 1607 generates and inputs an instruction for extracting various types of information related to the extraction target item from the target document into the first information extraction unit 1608, and the first information extraction unit 1608 uses the large language model to extract the information in accordance with the input instruction.

The instruction generation unit 1607 generates a prompt including the instruction for extracting various types of information related to the extraction target item from the target document as well as the character string included in the image data of the target document and position information of the character string and inputs the prompt into the first information extraction unit 1608. In the present embodiment, various types of information related to the extraction target item to be extracted from the target document include the item name (character string) corresponding to the extraction target item and the item contents (character string) corresponding to the item name as well as the position information (coordinate information) of the item name and the item contents. The instruction generation unit 1607 may also generate a prompt with the document information or the like of documents with high similarity to the target document (for example, documents with an average IoU equal to or higher than the threshold) as an example for few-shot learning and input the prompt into the first information extraction unit 1608. In this way, by providing information on a document with high similarity to the target document to the large language model as an example for few-shot learning, the accuracy of extraction of the item name and the item contents corresponding to the extraction target item from the target document can be improved.

The first information extraction unit 1608 performs inference with the large language model based on the prompt generated and input by the instruction generation unit 1607 to extract various types of information related to the extraction target item instructed by the prompt from the image data of the target document. The modification unit 1609 receives a modification request from the user for the extraction result of information related to the target document by the first information extraction unit 1608 and modifies the extraction result in accordance with the modification request.

The information processing apparatus 100 according to the present embodiment can extract information related to the extraction target item instructed from the image data of the document based on the position information of the item name and the item contents using the document information of the documents processed in the past by the second information extraction unit 1610. The second information extraction unit 1610 extracts various types of information related to the extraction target item instructed from the image data of the target document based on the position information of the item names and the item contents in the document information of the documents processed in the past. Specifically, the second information extraction unit 1610 refers to the reference document selected from among the documents processed in the past by the selection unit 1606 to extract various types of information related to the extraction target item from the target document based on the position information of the item name and the item contents in the reference document.

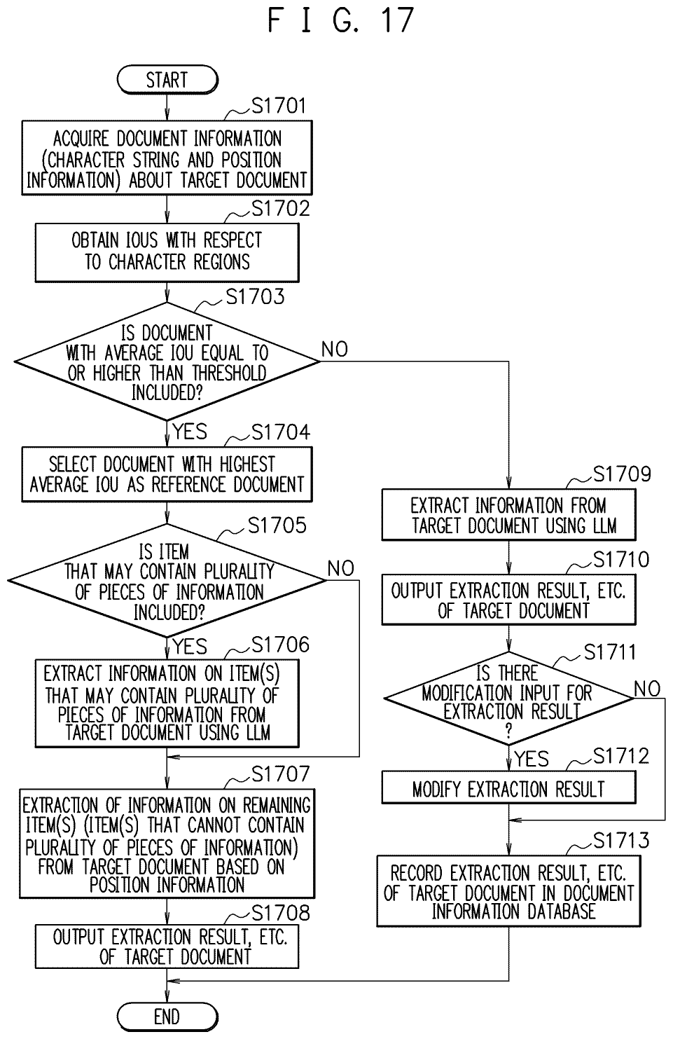

FIG. 17 is a flowchart illustrating an example of processing of the information processing apparatus 100 according to the third embodiment.

In step S1701, the acquisition unit 1604 acquires the image data by scanning or capturing the document to be processed (target document) and performs optical character recognition processing on the acquired image data to acquire the character string included in the image data of the target document and position information of the character string. As the position information of a character string, for example, four values of a minimum x-coordinate, a minimum y-coordinate, a maximum x-coordinate, and a maximum y-coordinate of the character string in the XY coordinate system with one end point in the document (for example, the upper left point, the lower left point, or the like) as the origin are acquired. The rectangle defined by these four values is the bounding box that indicates the character string region (character region). In the optical character recognition processing, information indicating a width and a height of the document is acquired. The position information of the character string is normalized using the width and the height of the document acquired so that the values are within the range of 0 to 1. Using normalized position information enables a higher value as the average IoU to be obtained for documents similar in layout when viewed as an entire page even if the sizes of the documents are not the same, thereby improving the accuracy of selecting the documents to be the reference document.

In step S1702, the calculation unit 1605 calculates and obtains the overlap ratio (IoU) with respect to the character string regions (character regions) between the target document acquired in step S1701 and the documents processed in the past. The calculation unit 1605 also calculates and obtains the average overlap ratio (average IoU) based on the calculated overlap ratios (IoUs) of the character string regions (character regions). The calculation unit 1605 obtains the overlap ratios (IoUs) and the average overlap ratio (average IoU) with respect to the character string regions (character regions) based on the document information of the target document acquired in step S1701 and the information about the documents processed in the past stored in the storage unit 1603 in a manner similar to the second embodiment described above.

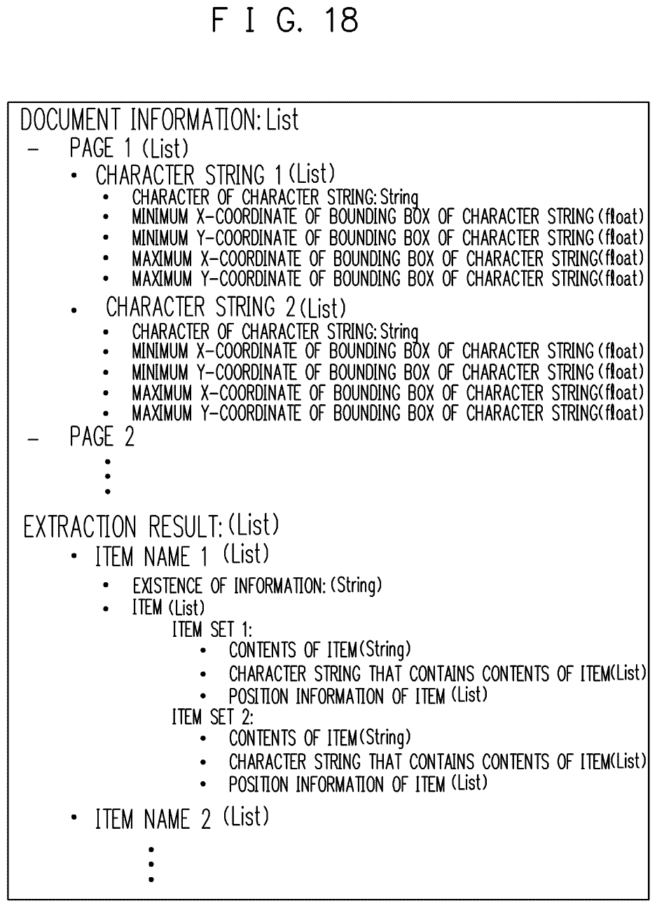

In the present embodiment, the information about the document processed in the past that is stored in the storage unit 1603 is described. FIG. 18 is a view describing the information about the document processed in the past that is stored in the storage unit 1603. The information about the document processed in the past is stored in json format as illustrated, for example, in FIG. 18. The character string and the position information of the bounding box surrounding the character string (position information of the character string) are stored on a page-by-page basis for each of the character strings included in a page. The position information of the bounding box is normalized so that the coordinates are between 0 and 1 based on the height and the width of the document (the vertical and horizontal sizes of the image data). As a result of the extraction, the item names and one or more information related to the item corresponding to the item names are stored. The information related to the item includes the contents of the item, the character string that contains the contents of the item (a pair of the character string and position information of the character string), and the position information of the item. The position information of the item is normalized so that the coordinates are between 0 and 1 based on the height and width of the document (the vertical and horizontal sizes of the image data).

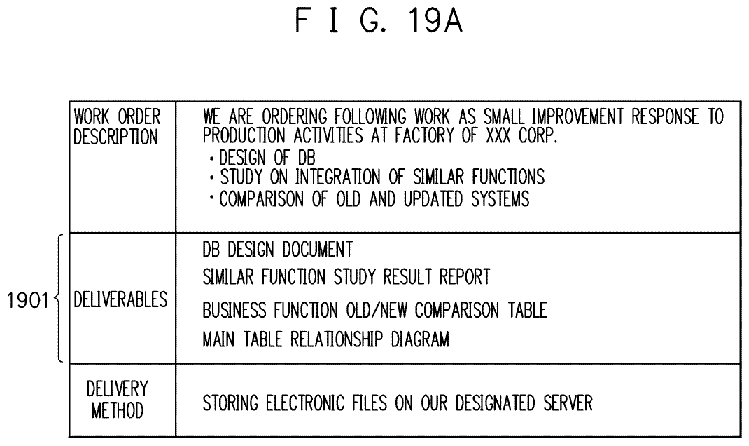

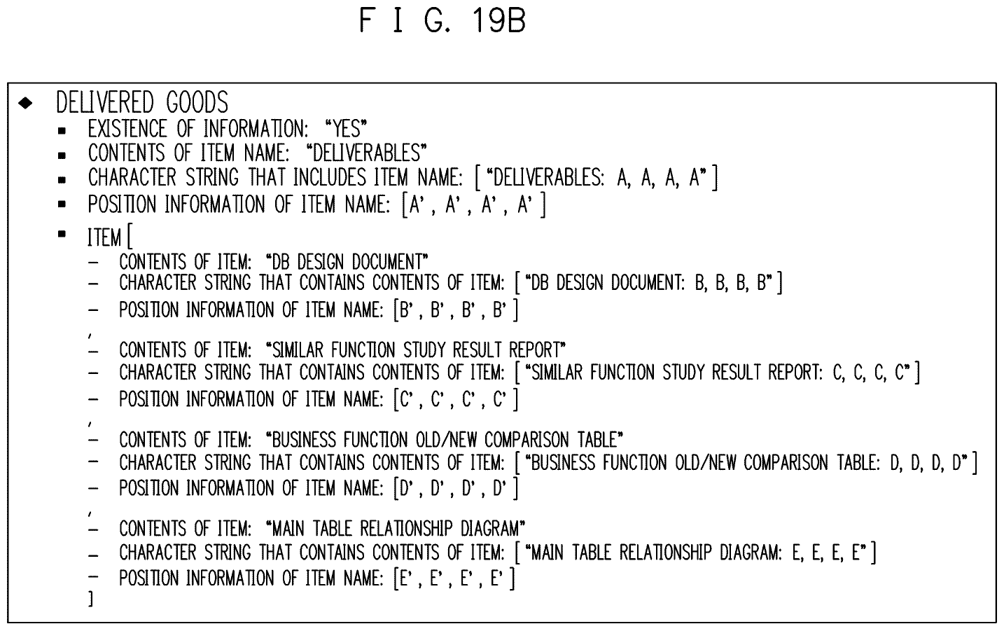

As an example, an example of the information about the document processed in the past that has been extracted from the document illustrated in FIG. 19A and stored in the storage unit 1603 is illustrated in FIG. 19B. FIG. 19B illustrates the information about the document illustrated in FIG. 19A that has been extracted and stored with delivered goods as the extraction target item. Information written in a field 1901 for “Deliverables” in the document illustrated in FIG. 19A is extracted and stored as the information corresponding to the extraction target item “Delivered goods.” As illustrated in FIG. 19B, since the document includes information corresponding to “Delivered goods,” which is the extraction target item, the existence of information is stored as “YES.” In addition, “Deliverables” is stored as the contents of the item name corresponding to “Delivered goods,” which is the extraction target item, and

“Deliverables: A, A, A, A” indicating the character string of “Deliverables” and its position information is stored as the character string that includes the item name. “A′, A′, A′, A′” is stored as the position information of the item name. Here, “A′, A′, A′, A′” is values for “A, A, A, A” normalized using the width and the height of the document, in other words, “A′, A′, A′, A′”=“A/(width), A/(height), A/(width), A/(height).” “DB design document,” “Similar function study result report,” “Business function old/new comparison table,” and “Main table relationship diagram” are also stored as the contents of this item. “DB design document: B, B, B, B,” “Similar function study result report: C, C, C, C,” “Business function old/new comparison table: D, D, D, D,” and “Main table relationship diagram: E, E, E, E” that indicate the character string and its position information of each of the items are stored as the character strings that contain the contents of the item, and the position information normalized for each based on the size of the document is stored as the position information of the item name.

Turning back to FIG. 17, in step S1703, the instruction generation unit 1607 determines whether the documents processed in the past include a document for which the average overlap ratio (average IoU) is equal to or higher than the threshold or not based on the average overlap ratio (average IoU) for each of the documents processed in the past that is obtained in step S1702. If the instruction generation unit 1607 determines that the documents processed in the past include a document for which the average overlap ratio (average IoU) is equal to or higher than the threshold (YES), the process in step S1704 is performed. If the instruction generation unit 1607 determines that the documents processed in the past do not include a document for which the average overlap ratio (average IoU) is equal to or higher than the threshold (NO), the process in step S1709 is performed.

In step S1704, which is performed when the instruction generation unit 1607 determines that the documents processed in the past include a document for which the average overlap ratio (average IoU) is equal to or higher than the threshold, the selection unit 1606 selects the document with the highest average overlap ratio (average IoU) from among the documents processed in the past as the reference document.

In step S1705, the control unit 1601 determines whether the extraction target items for which information is extracted from the target document include an item that may contain a plurality of pieces of information as the item contents in one item or not based on the reference document selected in step S1704. Whether an item that may contain the plurality of pieces of information is included or not, for example, may be determined by setting whether one item may contain the plurality of pieces of information as the item contents for each item in advance and determining whether an item that may contain the plurality of pieces of information is included or not based on that information. If the control unit 1601 determines that an item that may contain the plurality of pieces of information is included (YES), the process in step S1706 is performed. If the control unit 1601 determines that no item that may contain the plurality of pieces of information is included (NO), the process in step S1707 is performed without performing the process in step S1706.

In step S1706, the instruction generation unit 1607 and the first information extraction unit 1608 extract the item name and the item contents corresponding to the extraction target item that may contain the plurality of pieces of information from the target document using the large language model. Specifically, the instruction generation unit 1607 generates a prompt to be provided to the large language model for extracting information on the item that may contain the plurality of pieces of information from the target document. The instruction generation unit 1607 generates a prompt including the instruction for extracting the information corresponding to the extraction target item that may contain the plurality of pieces of information from the target document as well as the character string and position information of the character string related to the target document. The instruction generation unit 1607 generates a prompt further including the information about the reference document (character string and position information of the character string related to document as well as the extraction result) selected in step S1704 as an example for few-shot learning.

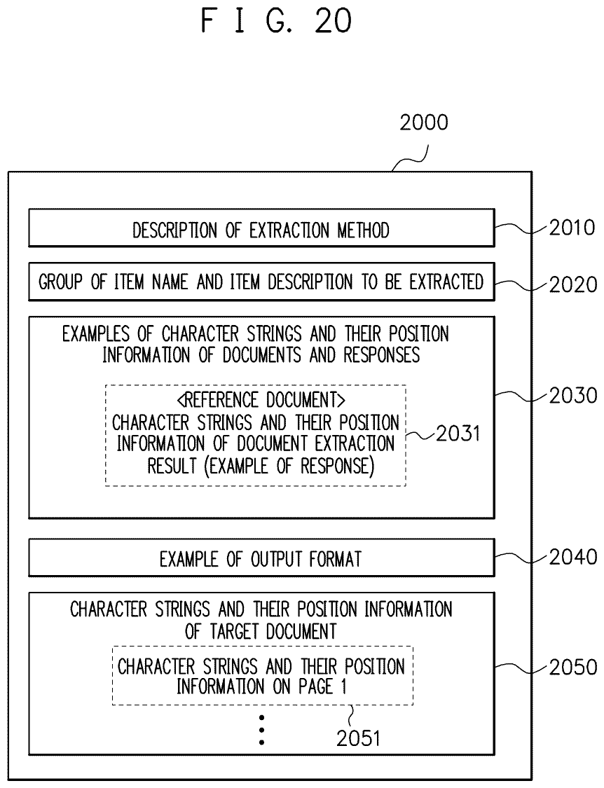

An example of a prompt generated by the instruction generation unit 1607 is illustrated in FIG. 20. As illustrated in FIG. 20, the prompt 2000 includes a description of an extraction method with respect to information from a document 2010, a group of the item names and the item descriptions to be extracted 2020, examples of character strings and their position information of the documents processed in the past and responses 2030 and an example of an output format 2040 as well as the character strings and their position information of the target document 2050. The description of the extraction method 2010 is a description of the method of extracting information of the item to be extracted from the target document. The group of the item names and the item descriptions to be extracted 2020 is a description of the item names and the items with respect to one or more items to be extracted. Including the descriptions of the items in the prompt enables updating knowledge with respect to the items that the large language model has and allowing learning of knowledge with respect to the items that the large language model does not have, thereby enabling accurate extraction of the information corresponding to a specified item. Examples of character strings and their position information of the documents processed in the past and responses 2030 are examples (samples) for few-shot learning and include the information (character string and its position information of the document as well as the extraction result) about the reference document selected from the documents processed in the past 2031. The example of the output format 2040 is an example of the output format when outputting the information corresponding to the item to be extracted as the extraction result. The character strings and their position information of the target document 2050 are the character strings and their position information contained in the target document acquired in step S1701 and includes a character string and its position information of a page of the target document 2051.

After the instruction generation unit 1607 generates the prompt to be provided to the large language model, the first information extraction unit 1608 performs inference regarding information extraction by inputting the prompt generated into the large language model to extract the information corresponding to the extraction target item that may contain the plurality of pieces of information from the target document.

In step S1707, the second information extraction unit 1610 extracts information corresponding to remaining items among the extraction target items (items that cannot contain the plurality of pieces of information as item contents) from the target document based on the position information in the reference document selected in step S1704 and the position information in the target document. For example, the second information extraction unit 1610 extracts a character string that includes a center point of the rectangle (bounding box) calculated based on the position information acquired in step S1701 within the rectangle (bounding box) based on the position information of the item in the reference document as the information corresponding to the extraction target item (item contents). If the plurality of pieces of information are included as the position information of the item, the information may be extracted by a rectangle including all of the character strings of the corresponding item contents inside, in other words, a rectangle defined by the minimum x-coordinate, the minimum y-coordinate, the maximum x-coordinate, and the maximum y-coordinate in the position information of those character strings.

In step S1708, the control unit 1601 outputs the extraction result and the like of the target document corresponding to the extraction target item obtained in the processes of steps S1706 and S1707. The control unit 1601 may output the character string, its position information, and the like in the target document acquired in step S1701 together. After performing the process in step S1708, the information processing apparatus 100 completes the process illustrated in FIG. 17.

In the above description, the large language model is used to extract the item name and the item contents corresponding to the extraction target item that may contain the plurality of pieces of information. However, the item names and the item contents corresponding to all of the items to be extracted, not limited to the item that may contain the plurality of pieces of information, may also be extracted using the large language model. Regardless of whether an item that may contain the plurality of pieces of information is included or not, the prompt including the information about the reference document selected in step S1704 as an example for few-shot learning is provided to the large language model to extract the item name and the item contents corresponding to the extraction target item using the large language model.

In step S1709, which is performed when the instruction generation unit 1607 determines that the documents processed in the past do not include a document for which the average overlap ratio (average IoU) is equal to or higher than the threshold, the instruction generation unit 1607 and the first information extraction unit 1608 extract the information corresponding to each of the extraction target items from the target document using the large language model. Specifically, the instruction generation unit 1607 generates a prompt to be provided to the large language model for extracting the information corresponding to each of the extraction target items from the target document as illustrated in FIG. 20 as an example. At this point, the instruction generation unit 1607 may generate, for example, a prompt including an example of a document that shows how to extract information from a document or an example of the document processed in the past that is similar in format to the target document as an example for few-shot learning. The first information extraction unit 1608 performs inference regarding information extraction by inputting the prompt generated by the instruction generation unit 1607 into the large language model to extract the information corresponding to the extraction target item from the target document. Here, in the present embodiment, the item name corresponding to the extraction target item as well as the character string with respect to the item contents and its position information are extracted as information corresponding to the extraction target item. In other words, the contents of the item name corresponding to the extraction target item, the character string (and its position information) that includes the item name, and the position information of the item name as well as the contents of the item, the character string (and its position information) that includes the item, and the position information of the item are extracted from the target document as the information corresponding to the extraction target item. Note that in addition to these pieces of information, other information may be extracted from the target document.

In step S1710, the control unit 1601 outputs the extraction result and the like of the target document corresponding to the extraction target item obtained in the process of step S1709. Note that the control unit 1601 may output the character string, its position information, and the like in the target document acquired in step S1701 together.

In step S1711, the control unit 1601 determines whether there is a modification input for the extraction result of the target document output in step S1710 or not. The control unit 1601 determines, for example, that there is a modification input when a modification request from the user who has confirmed the output extraction result of the target document is confirmed. If the control unit 1601 determines that there is a modification input for the extraction result (YES), the process in step S1712 is performed. If the control unit 1601 determines that there is no modification input for the extraction result (NO), the process in step S1713 is performed without performing the process in step S1712.

In step S1712, the modification unit 1609 modifies the extraction result of the target document in response to the modification input for the extraction result.

In step S1713, the control unit 1601 stores the character string and its position information that are related to the target document and the extraction result in a database (storage unit 1603) while associating them with each other. The control unit 1601, for example, provides the target document with an identifier (ID) to be uniquely identified and stores the identifier (ID), the character string and its position information acquired in step S1701, and the extraction result obtained in step S1710 (or the extraction result modified after modification in step S1712) in the database while associating them with each other. After performing the process in step S1713, the information processing apparatus 100 completes the process illustrated in FIG. 17.

According to the third embodiment, the information processing apparatus 100 obtains the document similar in layout as the reference document based on the average overlap ratio (average IoU) with respect to the character string regions between the target document and the documents processed in the past from among the document information of the documents processed in the past and extracts the item name and the item contents corresponding to the extraction target item using the information about the reference document, thereby enabling accurate extraction of the item name and the item contents corresponding to the extraction target item from the target document. The information (character string) corresponding to the desired item can be extracted from the image data of the target document by inputting as appropriate the prompt including the instruction for extracting the information (character string) corresponding to the specified item and the document information of the target document into the large language model. In addition, by including (incorporating) the information (document information and extraction result) of the reference document obtained from the document processed in the past in the prompt as examples for few-shot learning and inputting the prompt into the large language model, information equivalent to tacit knowledge, business knowledge, or the like can be easily and efficiently learned without having to transcribe everything as sentences, thereby enabling accurate extraction of information (character string) corresponding to the desired item from the image data of the target document.

In the description above for the third embodiment, whether the target document and the document processed in the past include a character string at the same position or not is determined based on whether the center point of the rectangle calculated based on the position information of the character string included in the target document is included within the rectangle based on the position information in the document processed in the past or not. However, the determination of whether the target document and the document processed in the past include a character string at the same position or not is not limited to the above but may be performed by other methods. For example, the character string may be determined to be included at the same position if the distance between a center point of a rectangle calculated based on position information in the document processed in the past and the center point of the rectangle calculated based on the position information of the character string included in the target document is equal to or less than a certain threshold. A character string for which the distance between the center point of the rectangle calculated based on the position information in the document processed in the past and the center point of the rectangle calculated based on the position information of the character string included in the target document is the shortest may be defined as the character string that is included at the same position. A character string with the closest cosine similarity of character string from among a certain number of character strings in ascending order from the one with the shortest distance may be defined as the character string that is included at the same position. The determination of whether the character string is included at the same position or not may be performed by inputting an image in the vicinity of the character string into the large language model.

In the description above for the third embodiment, various types of information on the extraction target item are extracted by inputting the character string extracted from an image and information about the document processed in the past. However, the extraction of the information related to the extraction target item is not limited to the above but may be performed by another method of inputting the character string extracted from the image and the information about the document processed in the past together with an acquired image (hereinafter referred to as the “current image”) and an image of the document processed in the past (hereinafter referred to as “past image”). To distinguish between the current image and the past image, each of the images may be input together with the character string indicating the respective image. This enables the extraction of various types of information on the extraction target item with high accuracy using the large language model.

In the description above for the third embodiment, various types of information on the extraction target item are extracted using the large language model. This enables the extraction of the item names and the item contents with high accuracy even when the target document contains a plurality of character strings corresponding to the item name and the item contents. In the description above, the prompt to be input into the large language model includes information including the descriptions of the item and the extraction result of the document processed in the past. This enables the extraction of the item of the target document as the extraction target item with high accuracy by learning based on the information about the documents processed in the past, even when the extraction target item and the item name in the target document are different.

In the description above for the third embodiment, when the character string for the extraction target item cannot contain the plurality of pieces of information as the item contents (contain only a single piece of information as the item contents), an extraction target is extracted using the position information in the target document and the position information in the document processed in the past without using the large language model. This increases processing speed and reduces the amount of processing (amount of calculation) compared to the case of using the large language model.

Although in the second and third embodiments described above, the overlap ratio (IoU) with respect to the bounding box in the target document is calculated for all bounding boxes in the document processed in the past, the calculation may be performed only for the bounding box that contains an overlapping portion with the bounding box in the target document out of all bounding boxes in the document processed in the past.
(Condition 1) The minimum x-coordinate of the bounding box in the document processed in the past is equal to or smaller than the maximum x-coordinate of the bounding box in the target document
(Condition 2) The maximum x-coordinate of the bounding box in the document processed in the past is equal to or larger than the minimum x-coordinate of the bounding box in the target document
(Condition 3) The minimum y-coordinate of the bounding box in the document processed in the past is equal to or smaller than the maximum y-coordinate of the bounding box in the target document
(Condition 4) The maximum y-coordinate of the bounding box in the document processed in the past is equal to or larger than the minimum y-coordinate of the bounding box in the target document

The bounding box that satisfies all of these (conditions 1) through (condition 4) out of all the bounding boxes in the document processed in the past is identified as the bounding box that overlaps with the bounding box in the target document. Since this process can be performed simply by comparing the coordinates of the position information in the target document and the document processed in the past, computing the overlap ratio (IoU) by narrowing down the bounding boxes in the document processed in the past for which the overlap ratio (IoU) is calculated reduces the calculation time without decreasing accuracy.

Since the number of pages is almost the same among documents similar in layout, documents to be calculated may be narrowed down according to the difference in the number of pages between the target document and the documents processed in the past. For example, documents processed in the past whose number of pages differs from that of the target document by a certain threshold or smaller may be used as a target for calculation. Metainformation may be provided for each of the documents to narrow down the documents to be calculated based on the metainformation. For example, if the documents are company documents, the company names or the like may be provided as metainformation to the documents to identify documents processed in the past to which the same company name is provided as metainformation as the target for calculation. Narrowing down the documents to be calculated in this way can reduce the processing time.

### OTHER EMBODIMENTS

The present invention is realized by performing the following processes as well. Specifically, software (program) realizing the functions of one of the embodiments described above is supplied to a system or an apparatus via a network or various types of recording media. Then, the process is performed by a computer (or CPU, MPU, or the like) of the system or the apparatus, which reads and executes the program. A computer program product such as a computer-readable recording medium containing the program and the program can also be applied as an embodiment of the present invention. For example, a flexible disk, a hard disk, an optical disk, a magneto-optical disk, a CD-ROM, a magnetic tape, a non-volatile memory card, a ROM, or the like can be used as the recording medium.

It should be noted that the above embodiments merely illustrate concrete examples of implementing the present invention, and the technical scope of the present invention is not to be construed in a restrictive manner by these embodiments. That is, the present invention may be implemented in various forms without departing from the technical spirit or main features thereof.

The following apparatuses, methods, and the like are also included in the disclosure of the present embodiment.
(1) An information processing apparatus including:
   an acquisitor configured to acquire a character string included in image data of a document and position information indicating a position of the character string as document information;
   a converter configured to convert the document information acquired into a distributed representation;
   an information extractor configured to extract a character string corresponding to an item instructed by a prompt, by performing inference with a large language model by inputting the prompt including the document information acquired into the large language model;
   a storage configured to store the document information, the distributed representation, and an extraction result by the information extractor, related to a document in a storage unit while associating them with each other; and
   a selector configured to select a reference document from among documents processed in a past based on a distributed representation related to a document to be processed and distributed representations related to the documents processed in the past stored in the storage unit,
   wherein the prompt to be input for the document to be processed includes information about the reference document selected.
(2) The information processing apparatus according to (1), wherein
   the prompt to be input for the document to be processed includes the document information and the extraction result related to the reference document selected.
(3) The information processing apparatus according to (1) or (2), wherein
   the selector selects a certain number of documents from among the documents processed in the past as the reference documents in descending order of similarity between the distributed representation related to the document to be processed and the distributed representations related to the documents processed in the past.
(4) The information processing apparatus according to (1) or (2), wherein
   the selector selects a certain number of documents from among the documents processed in the past as the reference documents in ascending order of distance between the distributed representation related to the document to be processed and the distributed representations related to the documents processed in the past.
(5) The information processing apparatus according to any one of (1) to (4), including
   a modifier configured to receive a modification request for the extraction result by the information extractor and to modify the character string corresponding to the item in the extraction result in response to the modification request,
   wherein the document information, the distributed representation, and the extraction result modified, related to a document are stored in the storage unit while being associated with each other when modification is performed by the modifier.
(6) The information processing apparatus according to (5), wherein
   the selector selects the reference document from among documents processed in the past for which the document information, the distributed representation, and the extraction result modified, related to a document stored in the storage unit.
(7) The information processing apparatus according to any one of (1) to (6), wherein
   the selector selects the reference document by comparing the distributed representation related to the document to be processed and the distributed representations related to the documents processed in the past with the k-nearest neighbor method.
(8) The information processing apparatus according to any one of (1) to (7), wherein
   the prompt to be input for the document to be processed is generated by incorporating the document information and the extraction result related to the reference document stored in the storage unit.
(9) The information processing apparatus according to any one of (1) to (8), wherein
   the prompt includes a description of the item.
(10) The information processing apparatus according to (1) or (2), wherein
   the storage stores the document information and the extraction result by the information extractor related to a document in the storage unit while associating them with each other, the extraction result including position information with respect to a character string acquired, and
   wherein the selector selects the reference document from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.
(11) The information processing apparatus according to (10), including
   a calculator configured to calculate an overlap ratio between the character string region in the document to be processed and the character string regions in the documents processed in the past,
   wherein the selector selects the reference document from among the documents processed in the past based on the overlap ratio calculated by the calculator.
(12) The information processing apparatus according to (11), wherein
   the calculator calculates an overlap ratio of each of the character string regions in the document to be processed with the character string regions in the documents processed in the past and calculates an average overlap ratio as an average value of the largest overlap ratios for the respective character string regions calculated, for each of the documents processed in the past, and
   wherein the selector selects the reference document from among the documents processed in the past based on the average overlap ratio calculated for each of the documents processed in the past by the calculator.
(13) The information processing apparatus according to (12), wherein
   the selector selects a document having the highest average overlap ratio calculated from among the documents processed in the past as the reference document.
(14) The information processing apparatus according to (12), wherein
   the selector selects a certain number of documents in descending order of the average overlap ratio calculated from among the documents processed in the past as the reference documents.
(15) The information processing apparatus according to any one of (11) to (14), wherein
   the calculator calculates the overlap ratio of the character string regions only for a corresponding page in the document to be processed and the documents processed in the past.
(16) The information processing apparatus according to any one of (10) to (15), wherein
   the information extractor extracts:
   a character string corresponding to the item to be extracted from the document to be processed using the large language model, if the item to be extracted is an item that may contain a plurality of character strings; or
   a character string corresponding to the item to be extracted from the document to be processed based on position information of the character string in the reference document selected and position information of the character string in the document to be processed, if the item to be extracted is an item that contains only one character string.
(17) An information processing method performed by an information processing apparatus, including:
   acquiring a character string included in image data of a document and position information indicating a position of the character string as document information;
   converting the document information acquired into a distributed representation;
   information extracting a character string corresponding to an item that is instructed by a prompt, by performing inference with a large language model by inputting the prompt including the document information acquired into the large language model;
   storing the document information, the distributed representation, and an extraction result by the information extracting, related to a document in a storage unit while associating them with each other; and
   selecting a reference document from among documents processed in a past based on a distributed representation related to a document to be processed and distributed representations related to the documents processed in the past stored in the storage unit,
   wherein the prompt to be input for the document to be processed includes information about the reference document selected.
(18) The information processing method according to (17), wherein
   in the storing, the document information and the extraction result by the information extracting related to a document are stored in the storage unit while being associated with each other, the extraction result including position information with respect to a character string acquired, and
   wherein in the selection process, the reference document is selected from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.
(19) A program product (a computer program product) for causing a computer of an information processing apparatus to execute:
   acquiring a character string included in image data of a document and position information indicating a position of the character string as document information;
   converting the document information acquired into a distributed representation;
   information extracting a character string corresponding to an item that is instructed by a prompt, by performing inference with a large language model by inputting the prompt including the document information acquired into the large language model;
   storing the document information, the distributed representation, and an extraction result by the information extracting, related to a document in a storage unit while associating them with each other; and
   selecting a reference document from among documents processed in a past based on a distributed representation related to a document to be processed and distributed representations related to the documents processed in the past stored in the storage unit,
   wherein the prompt to be input for the document to be processed includes information about the reference document selected.
(20) The program product (a computer program product) according to (19), wherein
   in the storing, the document information and the extraction result by the information extracting related to a document are stored in the storage unit while being associated with each other, the extraction result including position information with respect to a character string acquired are stored in the storage unit while being associated with each other, and
   wherein in the selecting, the reference document is selected from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.
(21) A non-transitory computer-readable recording medium storing a program for causing a computer of an information processing apparatus to execute:
   acquiring a character string included in image data of a document and position information indicating a position of the character string as document information;
   converting the document information acquired into a distributed representation;
   information extracting a character string corresponding to an item that is instructed by a prompt, by performing inference with a large language model by inputting the prompt including the document information acquired into the large language model;
   storing the document information, the distributed representation, and an extraction result by the information extracting, related to a document in a storage unit while associating them with each other; and
   selecting a reference document from among documents processed in a past based on a distributed representation related to a document to be processed and distributed representations related to the documents processed in the past stored in the storage unit,
   wherein the prompt to be input for the document to be processed includes information about the reference document selected.
(22) The non-transitory computer-readable recording medium according to (21), wherein
   in the storing, the document information and the extraction result by the information extracting related to a document are stored in the storage unit while being associated with each other, the extraction result including position information with respect to a character string acquired are stored in the storage unit while being associated with each other, and
   wherein in the selecting, the reference document is selected from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.

What is claimed is:

1. An information processing apparatus comprising:
an acquisitor configured to acquire a character string included in image data of a document and position information indicating a position of the character string as document information;
a converter configured to convert the document information acquired into a distributed representation;
an information extractor configured to extract a character string corresponding to an item instructed by a prompt, by performing inference with a large language model by inputting the prompt including the document information acquired into the large language model;
a storage configured to store the document information, the distributed representation, and an extraction result by the information extractor, related to a document in a storage unit while associating them with each other; and
a selector configured to select a reference document from among documents processed in a past based on a distributed representation related to a document to be processed and distributed representations related to the documents processed in the past stored in the storage unit,
wherein the prompt to be input for the document to be processed includes information about the reference document selected.

2. The information processing apparatus according to claim 1, wherein
the prompt to be input for the document to be processed includes the document information and the extraction result related to the reference document selected.

3. The information processing apparatus according to claim 1, wherein
the selector selects a certain number of documents from among the documents processed in the past as the reference documents in descending order of similarity between the distributed representation related to the document to be processed and the distributed representations related to the documents processed in the past.

4. The information processing apparatus according to claim 1, wherein
the selector selects a certain number of documents from among the documents processed in the past as the reference documents in ascending order of distance between the distributed representation related to the document to be processed and the distributed representations related to the documents processed in the past.

5. The information processing apparatus according to claim 1, comprising
a modifier configured to receive a modification request for the extraction result by the information extractor and to modify the character string corresponding to the item in the extraction result in response to the modification request,
wherein the document information, the distributed representation, and the extraction result modified, related to a document are stored in the storage unit while being associated with each other when modification is performed by the modifier.

6. The information processing apparatus according to claim 5, wherein
the selector selects the reference document from among documents processed in the past for which the document information, the distributed representation, and the extraction result modified, related to a document stored in the storage unit.

7. The information processing apparatus according to claim 1, wherein
the selector selects the reference document by comparing the distributed representation related to the document to be processed and the distributed representations related to the documents processed in the past with a k-nearest neighbor method.

8. The information processing apparatus according to claim 1, wherein
the prompt to be input for the document to be processed is generated by incorporating the document information and the extraction result related to the reference document stored in the storage unit.

9. The information processing apparatus according to claim 1, wherein
the prompt includes a description of the item.

10. The information processing apparatus according to claim 1, wherein
the storage stores the document information and the extraction result by the information extractor related to a document in the storage unit while associating them with each other, the extraction result including position information with respect to a character string acquired, and
wherein the selector selects the reference document from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.

11. The information processing apparatus according to claim 10, comprising
a calculator configured to calculate an overlap ratio between the character string region in the document to be processed and the character string regions in the documents processed in the past,
wherein the selector selects the reference document from among the documents processed in the past based on the overlap ratio calculated by the calculator.

12. The information processing apparatus according to claim 11, wherein
the calculator calculates an overlap ratio of each of the character string regions in the document to be processed with the character string regions in the documents processed in the past and calculates an average overlap ratio as an average value of a largest overlap ratios for the respective character string regions calculated, for each of the documents processed in the past, and
wherein the selector selects the reference document from among the documents processed in the past based on the average overlap ratio calculated for each of the documents processed in the past by the calculator.

13. The information processing apparatus according to claim 12, wherein
the selector selects a document having a highest average overlap ratio calculated from among the documents processed in the past as the reference document.

14. The information processing apparatus according to claim 12, wherein
the selector selects a certain number of documents in descending order of the average overlap ratio calculated from among the documents processed in the past as the reference documents.

15. The information processing apparatus according to claim 11, wherein
the calculator calculates the overlap ratio of the character string regions only for a corresponding page in the document to be processed and the documents processed in the past.

16. The information processing apparatus according to claim 10, wherein
the information extractor extracts:
a character string corresponding to the item to be extracted from the document to be processed using the large language model, if the item to be extracted is an item that may contain a plurality of character strings; or
a character string corresponding to the item to be extracted from the document to be processed based on position information of the character string in the reference document selected and position information of the character string in the document to be processed, if the item to be extracted is an item that contains only one character string.

17. An information processing method performed by an information processing apparatus, comprising:
acquiring a character string included in image data of a document and position information indicating a position of the character string as document information;
converting the document information acquired into a distributed representation;
information extracting a character string corresponding to an item that is instructed by a prompt, by performing inference with a large language model by inputting the prompt including the document information acquired into the large language model;
storing the document information, the distributed representation, and an extraction result by the information extracting, related to a document in a storage unit while associating them with each other; and
selecting a reference document from among documents processed in a past based on a distributed representation related to a document to be processed and distributed representations related to the documents processed in the past stored in the storage unit,
wherein the prompt to be input for the document to be processed includes information about the reference document selected.

18. The information processing method according to claim 17, wherein
in the storing, the document information and the extraction result by the information extracting related to a document are stored in the storage unit while being associated with each other, the extraction result including position information with respect to a character string acquired, and
wherein in the selection process, the reference document is selected from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.

19. A non-transitory computer-readable recording medium storing a program for causing a computer of an information processing apparatus to execute:
acquiring a character string included in image data of a document and position information indicating a position of the character string as document information;
converting the document information acquired into a distributed representation;
information extracting a character string corresponding to an item that is instructed by a prompt, by performing inference with a large language model by inputting the prompt including the document information acquired into the large language model;
storing the document information, the distributed representation, and an extraction result by the information extracting, related to a document in a storage unit while associating them with each other; and
selecting a reference document from among documents processed in a past based on a distributed representation related to a document to be processed and distributed representations related to the documents processed in the past stored in the storage unit,
wherein the prompt to be input for the document to be processed includes information about the reference document selected.

20. The non-transitory computer-readable recording medium according to claim 19, wherein
in the storing, the document information and the extraction result by the information extracting related to a document are stored in the storage unit while being associated with each other, the extraction result including position information with respect to a character string acquired are stored in the storage unit while being associated with each other, and
wherein in the selecting, the reference document is selected from among the documents processed in the past based on, instead of the distributed representation, a character string region in the document to be processed indicated by the position information with respect to the document to be processed and character string regions in documents processed in the past indicated by the position information with respect to documents processed in the past stored in the storage unit.
